(19) United States
(12) Patent Application Publication
(10) Pub. No.: US 2019/0095556 A1
(43) Pub. Date: Mar. 28, 2019

(54) INFORMATION PROCESSING DEVICE, SIMULATION METHOD, AND NON-TRANSITORY RECORDING MEDIUM STORING SIMULATION PROGRAM

(71) Applicant: NEC Corporation, Minato-ku, Tokyo (JP)

(72) Inventors: Mineto SATOH, Tokyo (JP); Soichiro ARAKI, Tokyo (JP); Kenichiro FUJIYAMA, Tokyo (JP); Tan AZUMA, Tokyo (JP)

(73) Assignee: NEC Corporation, Minato-ku, Tokyo (JP)

(21) Appl. No.: 16/086,673

(22) PCT Filed: Mar. 23, 2017
(86) PCT No.: PCT/JP2017/011604

§ 371 Date: Sep. 20, 2018

(30) Foreign Application Priority Data
Mar. 31, 2016 (JP) 2016-071460

(51) Int. Cl. G06F 17/50; G06N 5/02

(52) U.S. Cl. CPC G06F 17/5009; G06F 2217/16; G06N 5/02

(57) ABSTRACT

Disclosed is an information processing device that executes a simulation with high accuracy. The information processing device calculates a prediction value reflecting uncertainty of the mathematical model on basis of first-parameters values assumed to be constant at grid points generated by discretizing a calculation domain of the simulation, second-parameters values assumed to be inconstant, and given data; iteratively updates the prediction values and the second-parameters values to improve a degree of consistency between the prediction values and observation values reflecting uncertainty; and iteratively updates the first-parameters value and controls update processing of the prediction values and the second-parameters.

### TECHNICAL FIELD

The present invention relates to an information processing system, an information processing device, a simulation method, a simulation program, and the like.

### BACKGROUND ART

A simulation is a technique for mathematically modeling a phenomenon occurring in the real world and a hypothetical situation and numerically calculating in accordance with a mathematical model generated through the modeling by a computer. In a simulation, mathematical modeling allows for calculation with freely set time and space. Such a simulation allows for prediction of a situation in which it is difficult to acquire an actual result (e.g. a situation at a location where observation is difficult), or future events. Further, a simulation enables an analysis of a characteristic and a behavior in a situation which is difficult to observe in real world by intentionally changing a calculation condition. A simulation result may be helpful for an indicator in theoretically clarifying or designing a causal relation, or preparing a plan.

PTLs 2 and 3 disclose examples of a device executing a simulation. The simulation device disclosed in PTL 2 simulates traffic flows on roads in a specific section in a region, based on data representing structures of roads in the region and traffic flow parameters. PTL 3 discloses a simulation method of executing two mutually connected simulations.

For example, a simulation using a mathematical model is also helpful when a data obtaining period is insufficient with respect to actually obtained observation data, or observation data includes a missing value due to a sensor failure or the like. A simulation is helpful for grasping a situation with a temporally and spatially uneven distribution. The simulation is helpful for widely and continuously grasping and understanding the above-described situations. Precise estimation of a time-independent parameter out of parameters in a mathematical model can achieve highly accurate reproduction of an actual behavior with a simulation.

PTL 1 discloses an example of estimation method using a Kalman filter. The estimation method is a typical parameter estimation method in case that a mathematical model and observation data (hereinafter also simply referred to as “data”) do not include any uncertainty. In this example, a parameter in a given battery equivalent circuit model is estimated based on observation data acquired by observing a battery. PTL 1 discloses a method of estimating the parameter as a probability distribution characterized by an average value and a variance. However, PTL 1 does not mention uncertainty of a mathematical model and observation data.

On the other hand, a phenomenon itself occurring in a complex and diverse field such as agriculture, healthcare, weather, or soil is complicated, and therefore, in modeling of the phenomenon, a parameter related to the phenomenon may be omitted, or an approximation may be included due to a constraint on calculation. In other words, when targeting such a field, a mathematical model is merely a mathematical simulation of a real world. Accuracy of the model depends on whether or not reality occurring in the field is understood and an understood phenomenon is precisely simulated. In this case, the mathematical model often includes uncertainty. Additionally, observation data tend to cause an error dependent on an object, a measurement environment, or a measuring instrument, and therefore include uncertainty. When a case that a mathematical model and observation data include uncertainty, causal determination for uncertainty is impossible. Such uncertainty is, for example, uncertainty due to unsuitable parameter adjustment or uncertainty due to a limitation caused by definition of the mathematical model itself (e.g. out of a parameter adjustment range). Accordingly, an error has to be eventually reduced by adjusting parameters. Consequently, in adjusting the parameters, the parameters are estimated by an unsuitable or local optimization and therefore estimation accuracy in a simulation degrades.

Various concepts using an ensemble (group) as a simulation method have been proposed for a case that a mathematical model and observation data include uncertainty. A data assimilation technique is an example of the various concepts handling variables of a model as an ensemble. The data assimilation is a well-known technique for incorporating observation data acquired from reality into a simulation while considering uncertainty of the observation data and a mathematical model. The data assimilation has particularly developed in fields of earth science, oceanography, and meteorology. The data assimilation handles variables calculated in a simulation as an ensemble. The data assimilation searches the ensemble for a simulation result best matching observation data acquired from a real world, and updates the model itself and a simulation condition based on the result.

For example, NPL 1 describes a method of estimating time-independent parameters in data assimilation that uses a particle filter being one of methods using an ensemble. In the literature, a Markov chain Monte Carlo (MCMC) method is used as a method of estimating a parameter. However, since the method uses a Markov chain, a Markov chain needs to be newly generated every time new observation data are acquired on a time-series basis. In other words, the method is an off-line or batch-processing-like estimation method. Accordingly, the method is not necessarily suitable as an estimation method in which observation data gathering needs to be continuously performed and also a state calculated by a mathematical model needs to be always maintained at a latest estimate value including a parameter thereof. In other words, the method is not necessarily suitable as a parameter estimation method for an on-line application from a viewpoint of calculation efficiency thereof.

### CITATION LIST

### Patent Literature

PTL 1: Japanese Unexamined Patent Application Publication No. 2015-81800
PTL 2: Japanese Unexamined Patent Application Publication No. 2013-137715
PTL 3: Specification of U.S. Patent Application Publication No. 2001/0032068

### Non-Patent Literature

NPL 1: 4. Andrieu et al., “Particle Markov chain Monte Carlo methods”, J. R. Statist. Soc. B (2010), Volume 72, Issue 3, pp. 269-342

### SUMMARY OF INVENTION

### Technical Problem

In the aforementioned related art, use of one specification method as an estimation method of a parameter contributing to high precise accuracy of a time-independent simulation is a starting point of a resolution. However, a simulation that reproduces a phenomenon occurring in the real world or a hypothetical situation sometimes includes uncertainty in a mathematical model and observation data. In the simulation, a number of parameters to be simultaneously estimated (i.e. a dimension of parameters) may become diverse depending on obtaining status of the mathematical model and the observation data.

Technologies described in PTLs 1 to 3 have a problem of being limited to a case that a mathematical model is deterministic. Additionally, the technologies have a problem that a number of searches becomes enormous as a dimension of parameters increases. Accordingly, the technologies have a problem that a calculation amount for processing parameters exponentially increases as a dimension of the parameters increases. A technology described in NPL 1 uses a Markov chain. Accordingly, the technology has a scale advantage even when a dimension of parameters increases. However, when new observation data are acquired at a high frequency in an on-line situation, the technology needs to start Markov chain calculation all over again every time of obtaining observation data. Accordingly, the technology similarly has a problem that a calculation amount increases.

An object of the present invention is to provide a technology resolving the aforementioned problems.

### Solution to Problem

As an aspect of the present invention, an information processing device that executes simulation using a mathematical model and observation data including:

mathematical model calculation means for calculating a prediction value reflecting uncertainty of the mathematical model on basis of first-parameters values assumed to be constant at grid points generated by discretizing a calculation domain of the simulation, second-parameters values assumed to be inconstant, and given data;

local data processing means for iterating update of the prediction values and the second-parameters values to improve a degree of consistency between the prediction values and observation values reflecting uncertainty; and

global data processing means for iterating update of the first-parameters value and control of processing by the local data processing means.

In addition, as another aspect of the present invention, a simulation method with a mathematical model and observation data including:

mathematical model calculation means which calculates a prediction value reflecting uncertainty of the mathematical model on basis of first-parameters values assumed to be constant at grid points generated by discretizing a calculation domain of the simulation, second-parameters values assumed to be inconstant, and given data;

iterating update of the prediction values and the second-parameters values to improve a degree of consistency between the prediction values and observation values reflecting uncertainty; and

iterating update of the first-parameters value and control of update processing of the prediction values and the second-parameters.

In addition, as another aspect of the present invention, a simulation program simulating with a mathematical model and observation data and causing a computer to achieve:

a mathematical model calculation function for calculating a prediction value reflecting uncertainty of the mathematical model on basis of first-parameters values assumed to be constant at grid points generated by discretizing a calculation domain of the simulation, second-parameters values assumed to be inconstant, and given data;

a local data processing function for iterating update of the prediction values and the second-parameters values to improve a degree of consistency between the prediction values and observation values reflecting uncertainty; and

a global data processing function for iterating update of the first-parameters value and control of processing by the local data processing function.

As another aspect of the present invention, an information processing system including:

sensor for obtaining observation data;

information processing device for executing simulation based on a mathematical model by using the observation data; and

outputting means for requiring the information processing device for executing simulation based on the mathematical model and outputting a result of the simulation.

### Advantageous Effects of Invention

The present invention enables a simulation with high calculation efficiency without estimating unsuitable or locally optimum parameters, even when a mathematical model and data used in the simulation have uncertainty, and also a dimension of parameters to be estimated is high.

### BRIEF DESCRIPTION OF DRAWINGS

FIG. 1 is a block diagram illustrating a configuration of an information processing device according to a first example embodiment of the present invention.

FIG. 2 is a diagram illustrating an outline of display and an operation displayed by a simulation device as an information processing device according to a second example embodiment of the present invention.

FIG. 3 is a block diagram illustrating a functional configuration of the simulation device as the information processing device according to the second example embodiment of the present invention.

FIG. 4A is a diagram illustrating structures of a parameters storage unit and a classification condition storage unit according to the second example embodiment of the present invention.

FIG. 4B is a diagram illustrating structures of a given data storage unit and an observation data storage unit according to the second example embodiment of the present invention.

FIG. 4C is a diagram illustrating structures of a prediction values storage unit, a second-parameters storage unit and a first parameters storage unit according to the second example embodiment of the present invention.

FIG. 4D is a diagram illustrating a structure of a simulation processing table according to the second example embodiment of the present invention.

FIG. 5 is a block diagram illustrating a hardware configuration of a simulation device as an information processing device according to the second example embodiment of the present invention.

FIG. 6 is a flowchart illustrating a simulation procedure in the simulation device as the information processing device according to the second example embodiment of the present invention.

FIG. 7A is a diagram illustrating an outline of a simulation procedure according to the second example embodiment of the present invention.

FIG. 7B is a diagram illustrating an outline of a simulation procedure according to the second example embodiment of the present invention.

FIG. 7C is a diagram illustrating an outline of a simulation procedure according to the second example embodiment of the present invention.

FIG. 7D is a diagram illustrating an outline of a simulation procedure according to the second example embodiment of the present invention.

FIG. 7E is a diagram illustrating an outline of a simulation procedure according to the second example embodiment of the present invention.

FIG. 7F is a diagram illustrating an outline of a simulation procedure according to the second example embodiment of the present invention.

FIG. 7G is a diagram illustrating an outline of a simulation procedure according to the second example embodiment of the present invention.

FIG. 8 is a block diagram illustrating a functional configuration of a simulation device as an information processing device according to a third example embodiment of the present invention.

FIG. 9 is a diagram illustrating a structure of a local data processing allocation table according to the third example embodiment of the present invention.

FIG. 10 is a block diagram illustrating a functional configuration of a simulation device as an information processing device according to a fourth example embodiment of the present invention.

FIG. 11 is a diagram illustrating a structure of a simulation history database according to the fourth example embodiment of the present invention.

FIG. 12 is a block diagram illustrating a configuration of an information processing system including an information processing device according to a fifth example embodiment of the present invention.

FIG. 13A is a sequence diagram illustrating an operation sequence of the information processing system according to the fifth example embodiment of the present invention.

FIG. 13B is a diagram illustrating an outline of display and operation in a user terminal according to the fifth example embodiment of the present invention.

FIG. 14 is a block diagram illustrating a functional configuration of a simulation device as the information processing device according to the fifth example embodiment of the present invention.

FIG. 15 is a diagram illustrating a structure of a simulation processing table according to the fifth example embodiment of the present invention.

FIG. 16 is a diagram illustrating a classification example of farming environment parameters as parameters values according to the fifth example embodiment of the present invention.

FIG. 17 is a block diagram illustrating a functional configuration of a simulation device as an information processing device according to a sixth example embodiment of the present invention.

FIG. 18 is a diagram illustrating a structure of a simulation processing table according to the sixth example embodiment of the present invention.

FIG. 19 is a block diagram illustrating a functional configuration of a simulation device as an information processing device according to a seventh example embodiment of the present invention.

FIG. 20 is a diagram illustrating a structure of a simulation processing table according to the seventh example embodiment of the present invention.

### EXAMPLE EMBODIMENT

Example embodiments of the present invention will be exemplarily described in detail below with reference to drawings. However, components described in the following example embodiment are mere exemplifications, and are not intended to limit the technical scope of the present invention thereto. Further, an arrow in each block diagram indicates an example of a direction of a signal (data, information) flow, and therefore the signal (data, information) may travel in a direction reverse to the arrow.

Parameters to be estimated are herein generically called parameters values.

### First Example Embodiment

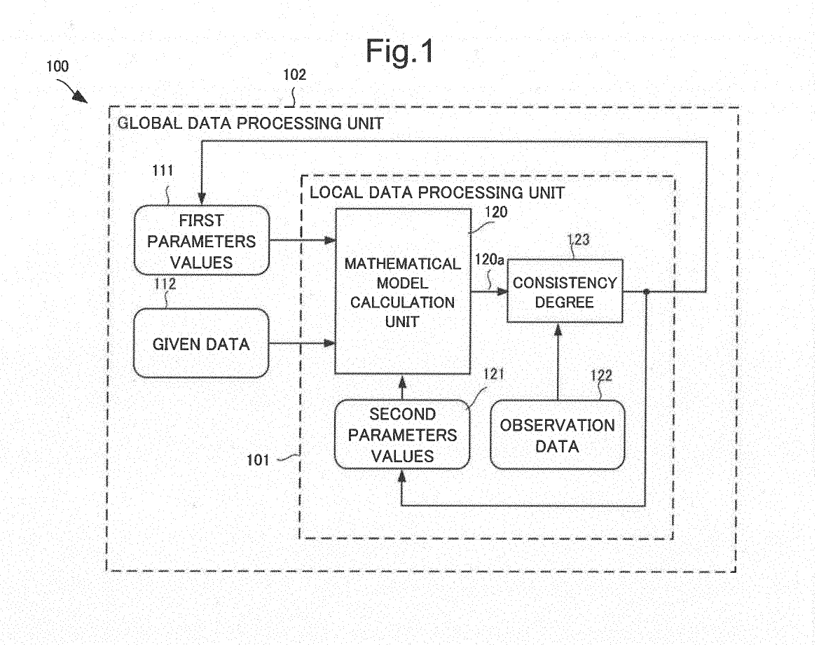

An information processing device 100 according to a first example embodiment of the present invention will be described with reference to FIG. 1.

The information processing device 100 performs a numerical calculation by a computer in accordance with a model mathematically representing a phenomenon occurring in the real world or a hypothetical situation. The information processing device 100 performs simulation by use of the mathematical model and observation data. As illustrated in FIG. 1, the information processing device 100 includes a local data processing unit (local data processor) 101 and a global data processing unit (global data processor) 102. The local data processing unit 101 includes a mathematical model calculation unit (mathematical model calculator) 120. The mathematical model calculation unit 120 calculates prediction values including uncertainty about a mathematical model, based on first parameters values 111, second parameters values 121, and known given data. The first parameters values 111 are assumed to be constant at grid points obtained by discretizing a calculation domain in a grid-like manner in a simulation. The second parameters values 121 are assumed to be not constant at the respective grid points. The local data processing unit 101 iterates update of prediction values 120a and the second parameters values 121 in such a way as to improve a consistency degree (a degree of consistency) 123 indicating a degree of consistency between the prediction values 120a and observation data 122 including uncertainty. The global data processing unit 102 performs control in such a way as to iterate the processing of the local data processing unit 101 while iterating update of the first parameters values 111.

The first parameters values 111 are assumed to be constant at each grid point obtained by discretizing a calculation domain in a grid-like manner in a simulation. In other words, the first parameters values 111 are a set of a single value in a simulation. Further, the second parameters values 121 are assumed to be not constant at each grid point obtained by discretizing a calculation domain in a grid-like manner in a simulation. In other words, the second parameters values 121 is a set of different values in a simulation.

The present example embodiment performs local data processing in such a way as to improve a consistency degree between prediction values and observation data while updating second parameters values assumed not to be constant at respective grid points, and also executes global data processing in such a way as to improve the consistency degree between the prediction values and the observation data while updating first parameters values assumed to be constant at the respective grid points.

Accordingly, even when a mathematical model and data used in a simulation has uncertainty and a dimension of parameters to be estimated is high, a simulation with high calculation efficiency can be performed without unsuitable or locally optimum parameter being estimated. The present example embodiment is particularly effective when observation data have a temporally and spatially uneven distribution due to an insufficient obtaining period, missing data, or the like.

### Second Example Embodiment

Next, a simulation device as an information processing device according to a second example embodiment of the present invention will be described. The simulation device according to the present example embodiment classifies parameters values in a mathematical model into second parameters values, at least either when the parameters values are values not uniformly set within a calculation domain in the mathematical model and when the parameters values are initial values of time-varying variables. The simulation device classifies the parameters values into first parameters values, otherwise. Then, a global data processing unit performs control in such a way that the local data processing unit processes the parameters values while further iterating reclassification of the parameters values. Specifically, the update processing of first parameters values may be continued until a variation of the first parameters values for each update and a variation of a consistency degree reach threshold values or less. When the variations do not reach the threshold values or less after executing the update a predetermined number of times, reclassification processing of classifying the parameters values into first parameters values or second parameters values may be executed.

When a likelihood is calculated as an indicator indicating a consistency degree, and prediction values and second parameters values are updated, a sequential likelihood for each time step calculated in a mathematical model is used. When first parameters values are updated, a cumulative likelihood obtained by adding up predetermined steps of sequential likelihoods or more is used. A dimension of the first parameters values is higher than a dimension of the second parameters values.

For example, the update processing of prediction values and second parameters values is performed by inputting the prediction values and observation data, by use of a sequential Bayesian filter including a particle filter, an ensemble Kalman filter, a Kalman filter, or sequential importance sampling in relation to a sequential consistency degree. On the other hand, the update processing of first parameters values is performed by inputting values before updating the first parameters values and a cumulative consistency degree, by use of statistical sampling including the Markov chain Monte Carlo method.

### Outline of Present Example Embodiment

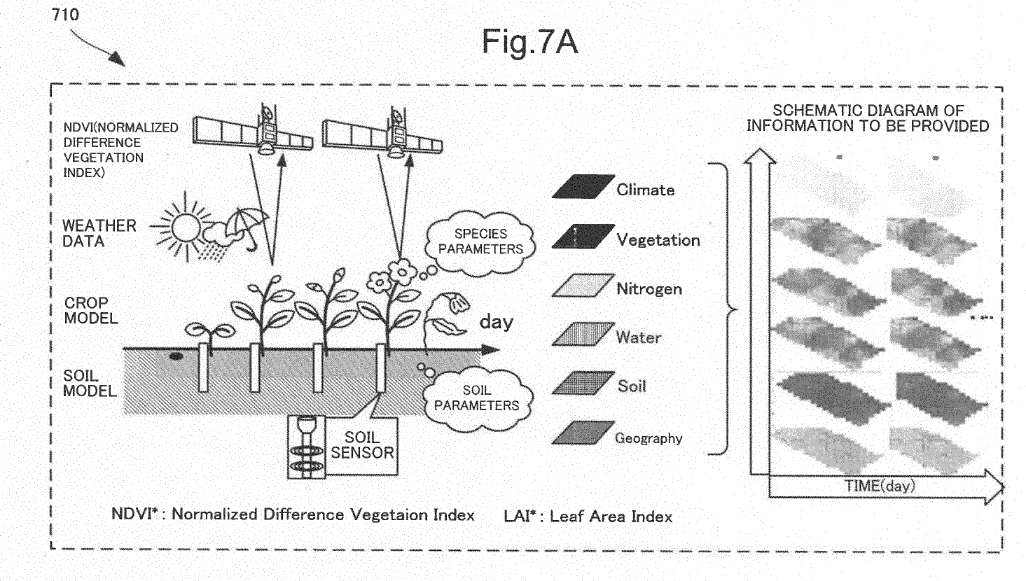

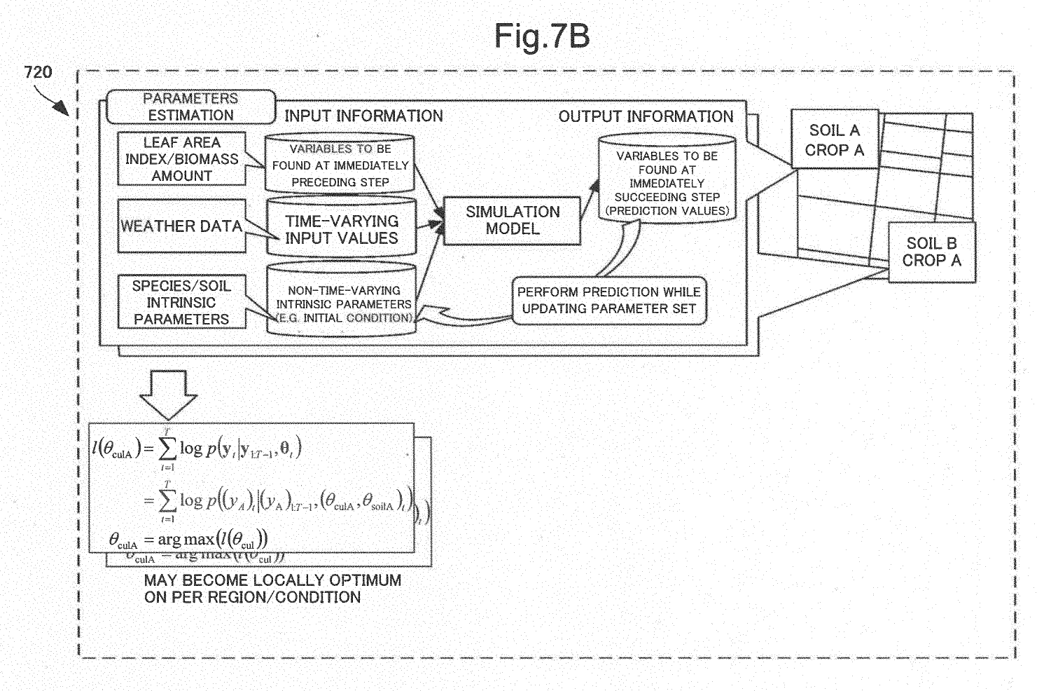

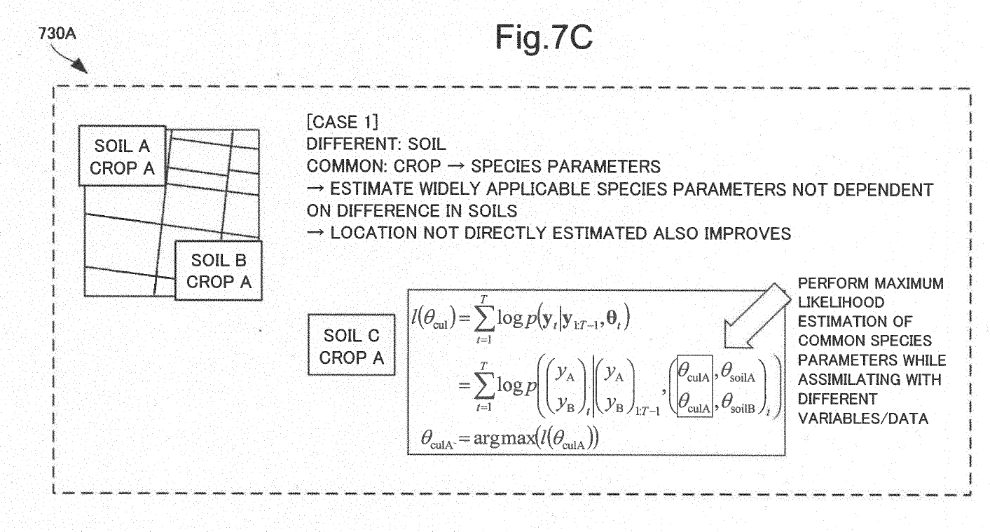

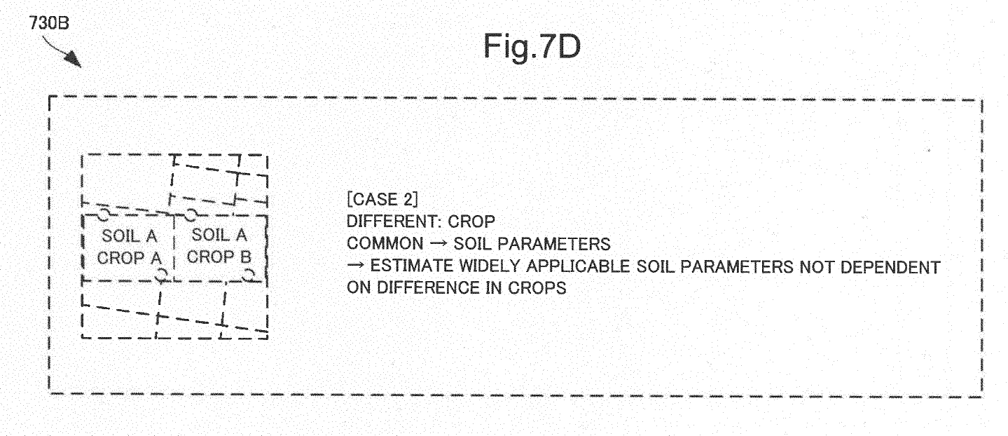

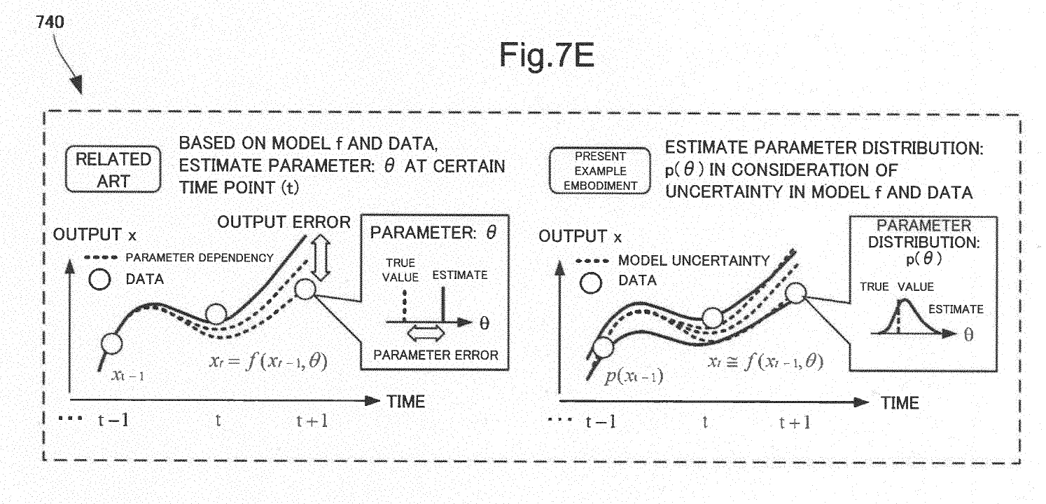

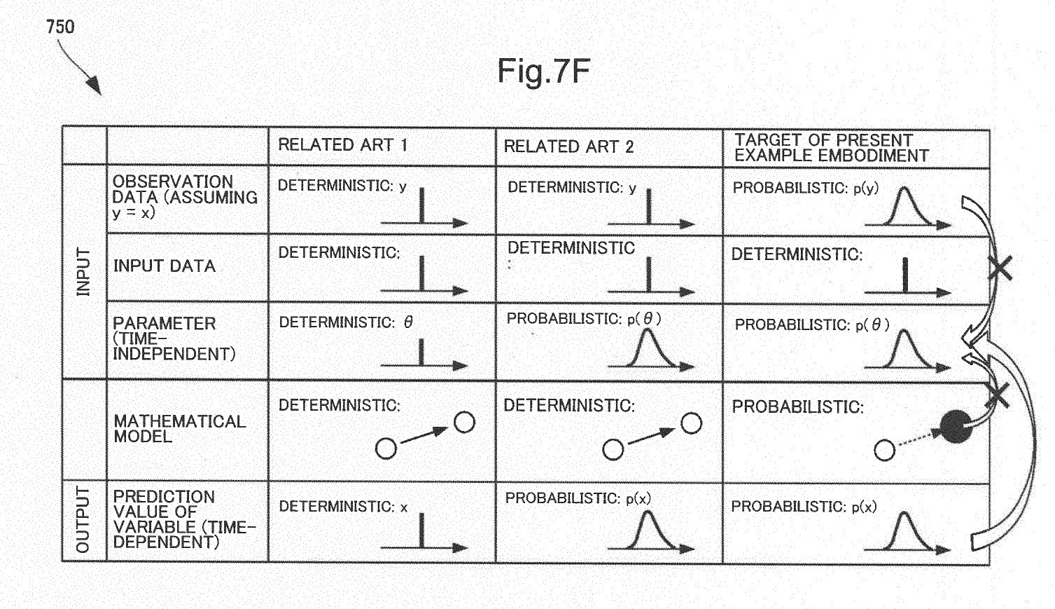

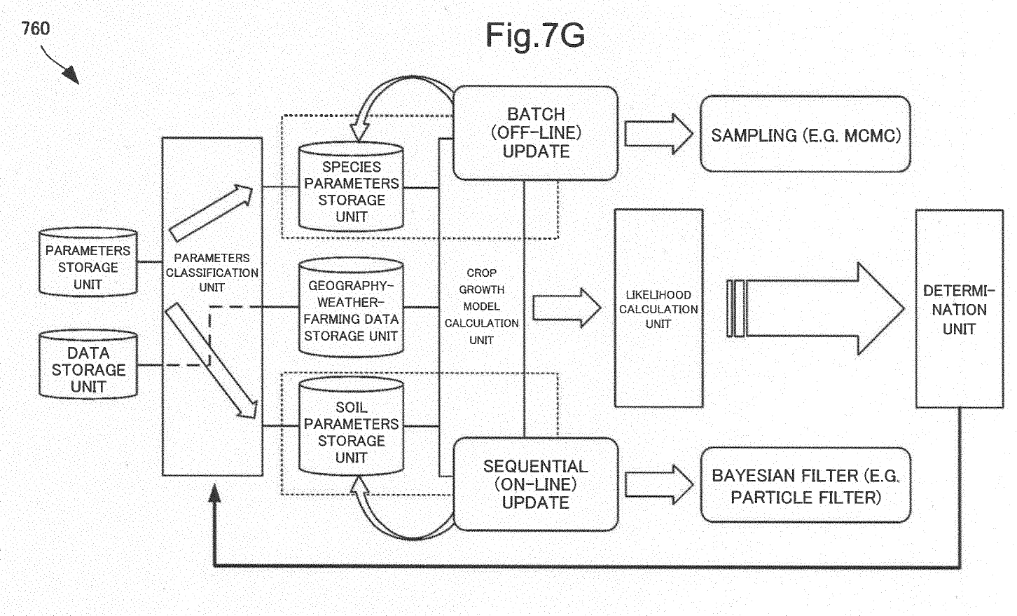

FIGS. 7A to 7G are diagrams illustrating an outline of simulation processing according to the present example embodiment. While the outline of the simulation processing according to the present example embodiment is described with farming support simulation as an example in FIGS. 7A to 7G, the processing is not limited to the farming support simulation.

Farming support simulation processing 710 in FIG. 7A generates a crop growth model including a crop model and a soil model. Then, the processing inputs species parameters, soil parameters, weather data, or the like to the crop growth model, and subsequently outputs prediction values. The species parameters include information temporally (or quantitatively) characterizing growth of a crop (e.g. a period from seeding to flowering). Further, the soil parameters include information physically (or chemically) characterizing a state of a soil [e.g. drain-ability and initial nitrogen (fertility)]. On the other hand, the processing inputs as observation data a normalized difference vegetation index (e.g. NDVI) calculated from a satellite image and detection data observed by a sensor such as a soil sensor, and generates and provides more accurate prediction information by data assimilation of the prediction values and the observation data.

A simulation method 720 being a related art illustrated in FIG. 7B inputs input information to one simulation model and generates prediction values by feeding back output information of the model. Therefore, when the simulation model or the input information has uncertainty, the simulation method 720 performs local optimization. Consequently, the simulation method 720 is not able to provide suitable prediction values.

With respect to a plurality of targets with mutually different conditions, simulation methods 730A and 730B according to the present example embodiment illustrated in FIGS. 7C and 7D, respectively, estimate parameters with commonality while reducing the difference by data assimilation. In other words, by processing of reducing, by data assimilation, a difference between output information calculated based on different pieces of input information (e.g. a variable value, weather, and a farming schedule) and observation values, output information having commonality and focusing on certainty about parameters to be estimated (e.g. a parameter likelihood) can be provided. Then, the methods further update the output information to a better parameter set by processing such as the MCMC method, based on the acquired parameter likelihood.

A case 1 exemplified in FIG. 7C is a case that a common crop is cultivated in a plurality of ranges including different soils in a target area. In the ranges in the calculation target area in this case, it is expected that soil parameters characterizing a state of a soil differ between locations (e.g. grid points), and species parameters characterizing a crop cultivated in each range are common between the ranges. As a first step in this case, the species parameters having commonality (global) in the target area are fixed to certain values, and then the soil parameters differing between locations (local) and other variables are estimated. By this method, the soil parameters and the other variables are suitably estimated under a constraint that the species parameters are common, based on input information differing between grid points (locations). Then, the estimation result is evaluated by certainty (likelihood) about the parameters. At a next step, the species parameters set to common fixed values are changed. With respect to the soil parameters and the other variables, a likelihood calculated based on a likelihood calculated by similar estimation processing is thereafter compared with a likelihood calculated based on previous species parameters. By iterating the step with varied species parameters, the most likely species parameters can be determined by values maximizing the likelihood in a state in which the soil parameters and the other variables are suitably estimated, respectively. In other words, expected species parameters with commonality (global) can be estimated without being influenced by a difference between soils, and uncertainty of other input information.

The species parameters derived in accordance with the method are parameters not dependent on a location (i.e. more versatile) as parameters characterizing a crop. Accordingly, calculation accuracy itself by a crop growth model improves by using the parameters. Specifically, prediction accuracy with respect to information at a grid point without input information such as observation data also improves.

A case 2 illustrated in FIG. 7D is a case that a soil is common, and crops cultivated in a plurality of ranges are different. In the ranges in a calculation target area in this case, it is expected that species parameters characterizing a crop differ between locations (i.e. grid points), and soil parameters characterizing a soil state are common independent of a location. As a first step in this case, the soil parameters, which is common (global) in the target area, are fixed to certain values, and then the species parameters, which differs between locations (local), and other variables are estimated. By iterating the step with varied soil parameters, the most likely soil parameters can be determined based on values maximizing the likelihood in a state in which the species parameters and the other variables are suitably estimated, respectively. In other words, expected soil parameters with commonality (global) can be estimated without being influenced by a difference between species, and uncertainty of other input information.

Similarly, the soil parameters derived in accordance with the method are parameters not dependent on a crop (i.e. more versatile) as parameters characterizing a soil. Accordingly, by using the parameters, calculation accuracy itself by a crop growth model improves. Specifically, accuracy with respect to information at a grid point without input information such as observation data improves.

A comparison 740 between the simulation method according to the related art and the simulation method according to the present example embodiment, the comparison being illustrated in FIG. 7E, illustrates a problem of the related art, a resolution method by the present example embodiment, and an effect thereof.

In order to highly accurately estimate a behavior of a system by use of a mathematical model in the related art illustrated in the left-hand diagram in FIG. 7E, it is important to highly accurately estimate time-independent parameters in the mathematical model. However, with regard to a target having uncertainty in a mathematical model or data in the related art, a cause of the uncertainty cannot be determined, and therefore an estimation result needs to be adjusted by parameters. Accordingly, the related art has a problem that estimation accuracy of the system degrades by unsuitable or locally optimum parameters being estimated. The related art has a problem that, as a dimension of estimated variables or parameters increases, a number of searches becomes enormous, and therefore a calculation amount explosively increases.

The resolution method according to the present example embodiment separates a probability distribution and uncertainty, and is illustrated in the right-hand diagram in FIG. 7E. The resolution method handles variables, data, and parameters in a mathematical model as a probability distribution, and therefore uncertainty related to the mathematical model is considered. Uncertainty dependent on the mathematical model and data, and uncertainty related to time-independent parameters in the mathematical model are separated, and each is estimated in accordance with a suitable method. In other words, with regard to parameters, parameters common (global) among a plurality of calculation points and local parameters are separately estimated.

Such a simulation method according to the present example embodiment separates influence due to uncertainty of a mathematical model and data, and is able to estimate parameters, based on ideal parameter dependency. Further, the method is able to separate estimation methods of variables and parameters depending on properties of the variables and the parameters and optimize each, and therefore a calculation amount required for simulation is reduced. Additionally, separating common (global) parameters and local parameters depending on a range of influence by the parameter improves simulation accuracy in a situation in which an amount of time-series observation data is small or a situation in which some observation data are missing, and estimation accuracy of common parameters at a plurality of calculation points.

FIG. 7F is a diagram illustrating a comparison table 750 between the simulation method according to the related art and the simulation method according to the present example embodiment. For example, while observation data are deterministically processed in the related art, observation data are probabilistically processed in the present example embodiment. The simulation method according to the present example embodiment adapts to input of probabilistic observation data and parameters having uncertainty, and a probabilistic mathematical model having uncertainty, and more accurately and promptly outputs prediction values of probabilistic variables having uncertainty.

FIG. 7G is a diagram illustrating a concept 760 of a simulation processing structure according to the present example embodiment. A parameters storage unit stores parameters required to be estimated (i.e. parameters values). The parameters classification (parameters classifier) unit classifies the parameters values into, for example, species parameters being global parameters and soil parameters being local parameters. Geography data, weather data, farming data, or the like are used as given data. A crop growth model is calculated based on the species parameters, the soil parameters, the geography data, the weather data, and the farming data. The species parameters being global parameters are batch (off-line) updated by sampling such as the MCMC method, and the soil parameters being local parameters are sequentially (on-line) updated by a Bayesian filter such as a particle filter or an ensemble Kalman filter.

Then, a likelihood between prediction values of the crop growth model and observation data are calculated. Classification into global parameters and local parameters by the parameters classification unit is updated based on such a likelihood.

“Global” are “Local” represents a type of the estimation method and does not limit properties of parameters. Global parameters may be locally estimated as-is. Further, local parameters may be globally estimated by, for example, a hierarchical model.

<<Display and Operation of Simulation Device>>

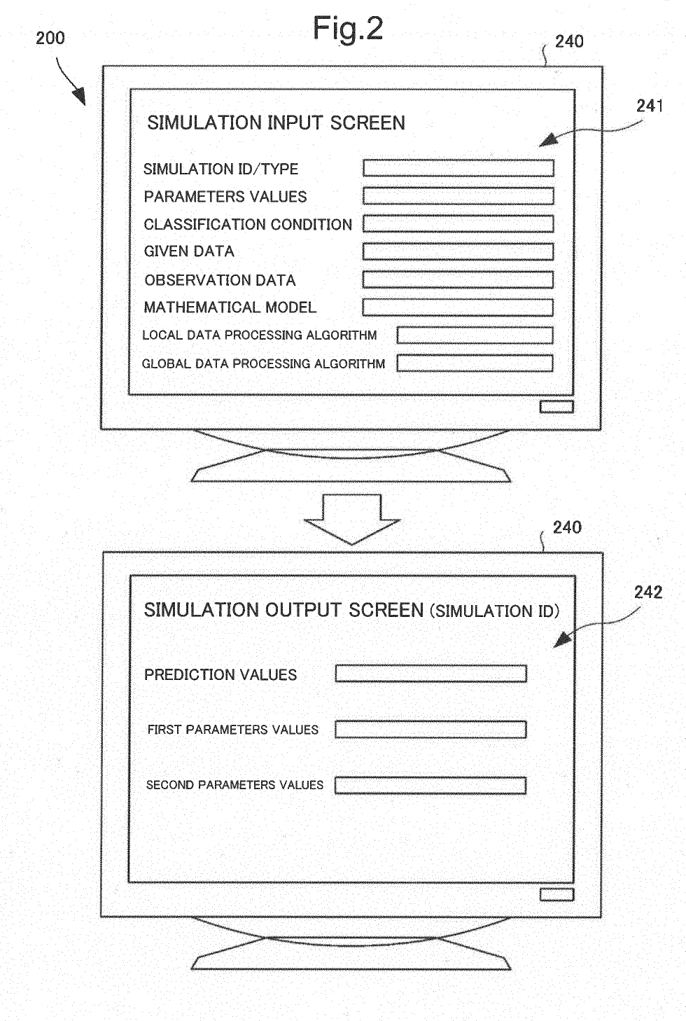

FIG. 2 is a diagram illustrating an outline of display and an operation displayed by a simulation device 200 as an information processing device according to the present example embodiment. FIG. 2 illustrates operation at a display-and-operator 240 included in or connected to the simulation device 200, a simulation input screen 241, and a simulation output screen 242.

The simulation input screen 241 displays entry fields for an identifier (ID) and a type for identifying a simulation, parameters values used in the simulation, a classification condition related to the parameters values, given data, observation data, a mathematical model, an algorithm related to local data processing, an algorithm related to global data processing, and the like. Not all the items need to be entered, and information that may be set by the simulation device 200 does not need to be entered.

On the other hand, the simulation output screen 242 after a simulation displays suitable values such as prediction values being a simulation result, first parameters values, second parameters values, and the like. When such output values are used as initial values in a subsequent similar simulation, a more suitable simulation can be provided more rapidly.

<<Functional Configuration of Simulation Device>>

The simulation device 200 according to the present example embodiment is applicable to a simulation tracking time evolution by solving a partial differential equation for continuous time and space. The partial differential equation is based on physical laws (a simulation using a so-called mathematical model). For example, such a partial differential equation includes an equation of motion describing a motion, the Navier-Stokes equation describing a fluid, a thermodynamic equation describing a thermal change, and a shallow water equation describing a tsunami. Further, the simulation device 200 is also applicable to a simulation using a finite element method. The above are hereinafter generically called a mathematical model. It is assumed that a system being a simulation target, in the present example embodiment, is a system in which prediction values of variables in a mathematical model (hereinafter simply referred to as “prediction values”) are associated with actual observation data by some relational expression (i.e. a system in which a simulation result is comparable with observation data). Then, in the present example embodiment, uncertainty related to a mathematical model is considered by statistically handling variables, data, and parameters in the mathematical model as probability distributions.

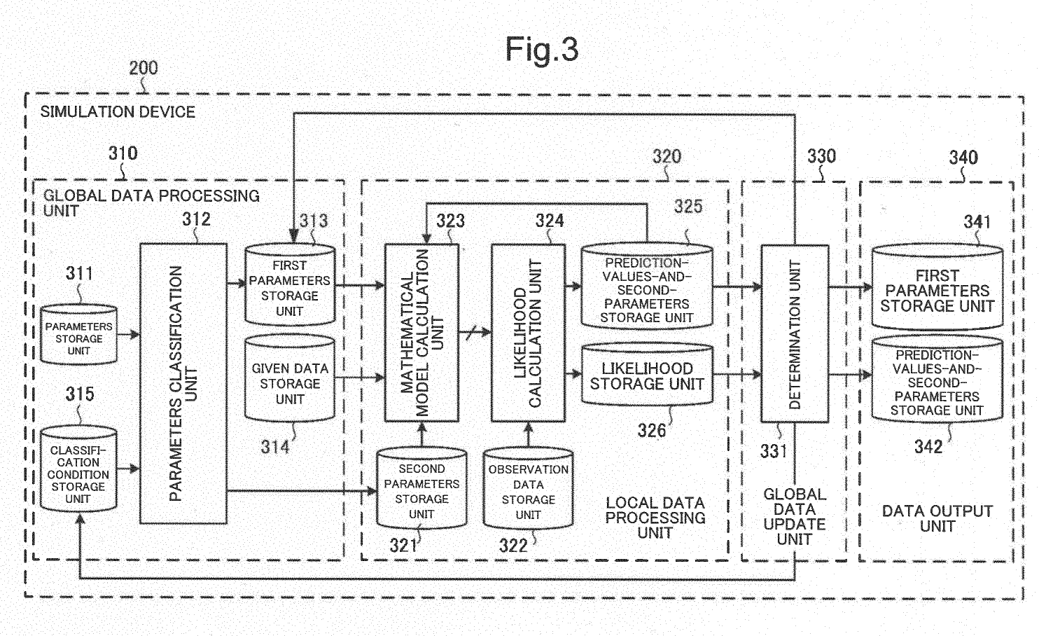

FIG. 3 is a block diagram illustrating a functional configuration of the simulation device 200 as the information processing device according to the present example embodiment.

In FIG. 3, the simulation device 200 includes a global data processing unit (global data processor) 310, a local data processing unit (local data processor) 320, a global data update unit (global data updater) 330, and a data output unit (data outputter) 340. The global data processing unit 310 includes a parameters classification unit (parameters classifier) 312, and includes as areas storing data a parameters storage unit 311, a first parameters storage unit 313, a given data storage unit 314, and a classification condition storage unit 315. The local data processing unit 320 includes a mathematical model calculation unit (mathematical model calculator) 323 and a likelihood calculation unit (likelihood calculator) 324, and includes, as areas storing data, a second parameters storage unit 321, an observation data storage unit 322, a prediction values-and-second-parameters storage unit 325, and a likelihood storage unit 326. The global data update unit 330 includes a determination unit (determiner) 331. The data output unit 340 includes, as areas storing data, a first parameters storage unit 341 and a prediction values-and-second-parameters storage unit 342. The global data processing unit 310 may include the global data update unit 330 and the data output unit 340.

(Global Data Processing Unit 310)

First, the global data processing unit 310 will be described. The global data processing unit 310 obtains values that need to be estimated (i.e. parameters values) out of parameters input to the mathematical model calculation unit 323, and given simulation conditions such as initial conditions of variables and a boundary condition. The global data processing unit 310 stores the values and the conditions into related storage areas being the parameters storage unit 311 and the given data storage unit 314, respectively. The parameters classification unit 312 classifies the parameters values (i.e. parameters that need to be estimated) stored in the parameters storage unit 311 into two different types being first parameters values and second parameters values, in accordance with the condition (or method) stored in the classification condition storage unit 315. Then, the parameters classification unit 312 stores the first parameters values into the first parameters storage unit 313 and stores the second parameters values into the second parameters storage unit 321 in the local data processing unit 320.

The classification processing into two different types by the parameters classification unit 312 in the global data processing unit 310 will be described. As a premise of the classification, it is assumed that properties (e.g. information such as which parameters in the mathematical model calculation unit 323 the parameters value relates to and what applicability and value are expected) of the respective parameters values stored in the parameters storage unit 311 are acquired. Further, it is also assumed that information such as a target calculation domain in the mathematical model calculation unit 323, an initial condition, and a boundary condition is acquired, and such information is stored in the given data storage unit 314. In such a situation, for example, parameters values that are not uniformly set at least in a calculation domain calculated by the mathematical model calculation unit 323 (i.e. not assumed to be constant at each grid point when the calculation domain is divided in a grid-like manner) are classified as second parameters values. Conversely, parameters values that are uniformly set (i.e. assumed to be constant at each grid point) are classified as first parameters values.

Further, as another example of a classification method, parameters values being initial values of time-varying parameters or variables may be classified as second parameters values, and the remainder may be classified as first parameters values. However, the classification methods are strictly exemplifications, and both or either of the aforementioned classification conditions or another classification method may be employed. The classification conditions or the classification methods are stored in the classification condition storage unit 315, independently of the parameters classification unit 312, and are added or updated by an output of a determination unit 331 to be described later. Information about a classification condition and a classification method includes information acquired dependently on a property of observed data and suitability of the classification, in addition to fixed information dependent on the aforementioned mathematical model calculation unit 323 and a simulation target. Specifically, an empirically and numerically suitable classification condition is added to the classification condition storage unit 315 for each combination of a simulation target and parameters values. The information becomes knowledge (know-how) for highly accurately estimating parameters values and is applicable to another similar case. Additionally, abstract information defined by a mathematical expression is also applicable to another different case.

(Local Data Processing Unit 320)

Next, the local data processing unit 320 will be described. The local data processing unit 320 includes the second parameters storage unit 321, the observation data storage unit 322, and the mathematical model calculation unit 323. The second parameters storage unit 321 stores second parameters values output by the global data processing unit 310. The observation data storage unit 322 stores observation data from various sensors and the like. The mathematical model calculation unit 323 is a generic term for models performing various simulations. The local data processing unit 320 includes the likelihood calculation unit 324 that, based on prediction values of variables calculated by the mathematical model calculation unit 323 and observation data stored in the observation data storage unit 322, calculates a likelihood between the prediction values and the observation data. Additionally, the local data processing unit 320 includes the prediction values-and-second-parameters storage unit 325 and the likelihood storage unit 326. The prediction values-and-second-parameters storage unit 325 stores prediction values updated based on a likelihood calculated by the likelihood calculation unit 324 and second parameters values. The likelihood storage unit 326 stores a likelihood calculated by the likelihood calculation unit 324.

Next, calculation by the mathematical model calculation unit 323 in the local data processing unit 320 will be described. For example, a mathematical model is a model f calculated on a per grid point k basis (k=1 to L, where L is an integer greater than or equal to 2). It is assumed that x_{t,k} denotes a value of a variable at a grid point k at a time t. Further, it is assumed that φ denotes first parameters values classified by the parameters classification unit 312 in accordance with the aforementioned conditions and stored in the first parameters storage unit 313. A first parameters values group is, for example, a set including one value. Further, second parameters values classified by and stored in the second parameters storage unit 321 are not assumed to be constant at each grid point. It is assumed that θₖ denotes a value at a grid point k. In other words, a second parameters values group is a set of different values. The variable x_{t,k} is predicted in accordance with Eqn. 1, with a value of the variable at the grid point k at a time (t−1) at an immediately preceding step being denoted as x_{t-1,k}. A value of the predicted variable x_{t,k} is referred to as “a prediction value.”

x_{t,k}=f(x_{t-1,k},φ,θₖ,v) (Eqn. 1)

v is generally called system noise and is a value numerically representing uncertainty in a mathematical model, and is also a value introduced as a probabilistic driving term acting on a variable. It is assumed that y_{t,k} denotes observation data stored in the observation data storage unit 322 and the observation data at a grid point k at a time t. A relation between the observation data y_{t,k} and a variable x_{t,k} at the same identical grid point k at the same time t is expressed as Eqn. 2, in accordance with a mapping h (a so-called observation model: hereinafter referred to as an “observation model”).

y_{t,k}=h(X_{t,k},w) (Eqn. 2)

Note that w is generally called observation noise and is a value numerically representing an effect of uncertainty about a mathematical model and uncertainty of observation data (i.e. an error caused by a measuring instrument, an error between an actual phenomenon and a model, and the like), and is also introduced as a probabilistic driving term acting on a variable. Eqn. 1 and Eqn. 2 are collectively referred to as a “state-space model.” A state-space model may be applied to a model and observation data including uncertainty. Consequently, uncertainty of a model and observation data may be handled independently of uncertainty of parameters values.

Ensemble approximation for probabilistically handling uncertainty of a model and observation data, and variables and parameters values will be described. It is hereinafter assumed that a variable x_{t,k} at a grid point k at a time t reflects system noise v representing uncertainty about a model f, observation noise w representing uncertainty about observation data, and probability distributions related to first parameters values and second parameters values, and is handled as a probability distribution p(x_{t,k}) rather than given data. Such a probability distribution may be represented by a set of N ensembles (i.e. an ensemble approximation in accordance with Eqn. 3).

{x_{t,k}⁽ⁱ⁾}ᵢ₌₁^{N} (Eqn. 3)

Other probability distributions may be represented similarly. Each ensemble may be calculated mutually independently, and therefore it is easy to apply the ensemble to a state-space model (i.e. Eqn. 1 and Eqn. 2). For example, in a case of N ensembles (where N is a natural number), N iterative calculations may be performed, or a parallel calculation including N pieces of parallelism may be performed; and a calculation method can be flexibly designed based on an available calculation resource.

Next, update processing of prediction values and second parameters values by the likelihood calculation unit 324 in the local data processing unit 320 will be described. A prediction value at a grid point k at a time t [i.e. a probability distribution p(x_{t,k}) at a grid point k at a time t], which is predicted in accordance with Eqn. 1, is a so-called prior probability distribution (hereinafter referred to as a “prior distribution”) in a framework related to Bayesian statistics. Calculation processing of a posterior probability distribution (hereinafter referred to as a “posterior distribution”) in a state that observation data y_{t,k} at a grid point k at a time t, the data being stored in the observation data storage unit 322, are acquired (i.e. an updated value) is expressed as processing written in Eqn. 4, based on Eqn. 2 and Bayes' theorem.

p(x_{t,k}|y_{t,k},φ,θₖ)∝p(y_{t,k}|x_{t,k},φ,θₖ)p(x_{t,k}) (Eqn. 4)

In the right side of Eqn. 4, p(y_{t,k}|x_{t,k},y,θₖ) is referred to as a likelihood and is an indicator of a consistency degree of a prediction value X_{t,k} with respect to observation data y_{t,k} when the prediction value x_{t,k}, a first parameters value φ, and a second parameters value θₖ are acquired. A posterior distribution for the second parameters value θₖ may be determined in accordance with processing expressed in Eqn. 5. In other words, a prior distribution is updated.

p(θₖ|y_{t,k},φ)∝∫p(y_{t,k},x_{t,k}|φ,θₖ)P(θₖ)dx=∫p(y_{t,k}|x_{t,k},φ,θₖ)p(x_{t,k}|φ,θₖ)p(θk)dx (Eqn. 5)

The likelihood calculated in this case is a sequential likelihood at a time t and is stored in the likelihood storage unit 326 for each time step. In the local data processing unit 320, calculation of the aforementioned prediction values and a likelihood is iterated over a predetermined period [from a start time (t=1) to an end time (t=T)]. In the process, prediction values and second parameters values stored in the prediction values-and-second-parameters storage unit 325 (after the update processing respectively expressed in Eqn. 4 and Eqn. 5) are returned to the mathematical model calculation unit 323 and are used for calculation of a value at a next time step (i.e. t) as a value at a time (t−1) indicated in Eqn. 1. On the other hand, when observation data y_{1,k}, y_{2,k}, . . . y_{T,k} at respective calculation grid points k in the mathematical model calculation unit 323 are acquired with respect to a period from a time 1 to a time T, a likelihood L(φ,θ) with respect to the data may be calculated in accordance with processing as written in Eqn. 6.

$$\begin{matrix}L ( ϕ , θ ) = \int p ( {y}_{t , k} , {y}_{t - 1 , k} , {y}_{t - 2 , k} , Λ , {y}_{T , k} \vert {x}_{t , k} , ϕ , {θ}_{k} ) d k \\ = {\prod }_{i = 1}^{T} p ( {y}_{i} \vert {y}_{1} , Λ , {y}_{i - 1} , ϕ , θ )\end{matrix} \qquad ( Eqn .6 )$$

The likelihood written in Eqn. 6 is added up with respect to a time, a variable, and a grid point, is a function of first parameters values φ and second parameters values θ, and is referred to as a so-called parameter likelihood (or a model likelihood).

An update method of prediction values x_{t,k}, and second parameters values θₖ, the method conforming to Eqn. 4 and Eqn. 5, will be specifically described. When observation values y_{t,k} at a time t as described above are obtained, for example, a Bayesian filter technique such as a particle filter, an ensemble Kalman filter, a Kalman filter, or sequential importance sampling may be applied as a method of calculating a posterior distribution on-line (or sequentially) from a prior distribution and a likelihood, based on Bayes' theorem. However, the technique is an exemplification and does not limit the method.

(Global Data Update Unit 330)

Next, an operation in the determination unit 331 in the global data update unit 330 will be described. The determination unit 331 reads updated prediction values and second parameters values after iteration of processing until an end time (t=T), the values being stored in the prediction values-and-second-parameters storage unit 325, and a parameter likelihood calculated in accordance with Eqn. 6 and stored in the likelihood storage unit 326. Based on the inputs, the determination unit 331 performs determination processing of whether or not to update first parameters values, determination processing of whether or not classification in the parameters classification unit 312 in the global data processing unit 310 is appropriate, and update processing of a classification condition, and provides feedback to the first parameters storage unit 313 and the classification condition storage unit 315, respectively. As a condition for the former determination on whether or not to update first parameters values, for example, there is a method of updating first parameters values at least once, and keeping variations in prediction values and second parameters values per update, and a value of a parameter likelihood to predetermined values or less.

Further, with regard to a condition for the latter determination on whether or not classification of parameters values is appropriate and update of the classification condition, for example, there is a method of changing a classification condition when a parameter likelihood does not become a predetermined value or less after performing the aforementioned processing of updating first parameters values a predetermined number of times or more. As a change example of a classification condition, there is a method of changing values assumed to be uniform in a calculation domain (i.e. values classified and estimated as first parameters values) to second parameters values in order to be independently estimated at respective grid points rather than being uniform in the calculation domain. Thus, including a dual feedback loop composed of a mechanism of updating estimated first parameters values themselves with a parameter likelihood as a determination indicator and a mechanism of changing an estimation method and a condition by changing classification as first parameters values or second parameters values is a characteristic not found in a common parameter estimation method. The predetermined value and number of times may be set to suitable values, based on an actual application example. Further, the determination method described herein is strictly an exemplification and does not limit the present example embodiment thereto.

A method of updating first parameters values in accordance with Eqn. 6 will be specifically described. As described above, as a method of calculating a posterior distribution from a prior distribution and a likelihood by Bayes' theorem, based on a cumulative value from a start time (t=1) to an end time (t=T) (i.e. off-line or in a batch-like manner), for example, a Markov chain Monte Carlo (MCMC) method may be employed. However, the technique is an exemplification and is not limiting the update method.

Compared with the aforementioned technique related to an on-line Bayesian filter, it is generally easier to apply a technique conforming to an off-line MCMC method to a case that a dimension of parameters values is high. When a dimension to be estimated becomes higher (i.e. a degree of freedom increases), a particle filter, out of on-line Bayesian filters, particularly needs to increase particles (i.e. a number of ensembles) for expressing a combination thereof. Otherwise the degree of freedom cannot be sufficiently expressed, and a prediction about a next time step may become inaccurate. Such a phenomenon is generally called degeneracy of particles or ensembles. On the other hand, the MCMC method generates a combination of multidimensional estimates at a next time step by a Markov chain, and therefore the aforementioned phenomenon with a particle filter is not likely to occur. Accordingly, setting a dimension of off-line estimated first parameters values higher than a dimension of on-line estimated second parameters values is considered to be a more preferable form from a viewpoint of a calculation resource or a viewpoint of accuracy of parameters values, according to the present example embodiment.

(Data Output Unit 340)

Next, an operation of the data output unit 340 will be described. The data output unit 340 includes the first parameters storage unit 341, and the prediction values-and-second-parameters storage unit 342. The first parameters storage unit 341 stores the aforementioned updated first parameters values. The prediction values-and-second-parameters storage unit 342 stores updated prediction values and second parameters values. Accordingly, the two aforementioned storage units store a calculated value of a mathematical model updated by observation data (i.e. a simulation result value), and respective updated results related to first parameters values and second parameters values that need to be estimated.

(Parameters Storage Unit 311 and Classification Condition Storage Unit 315)

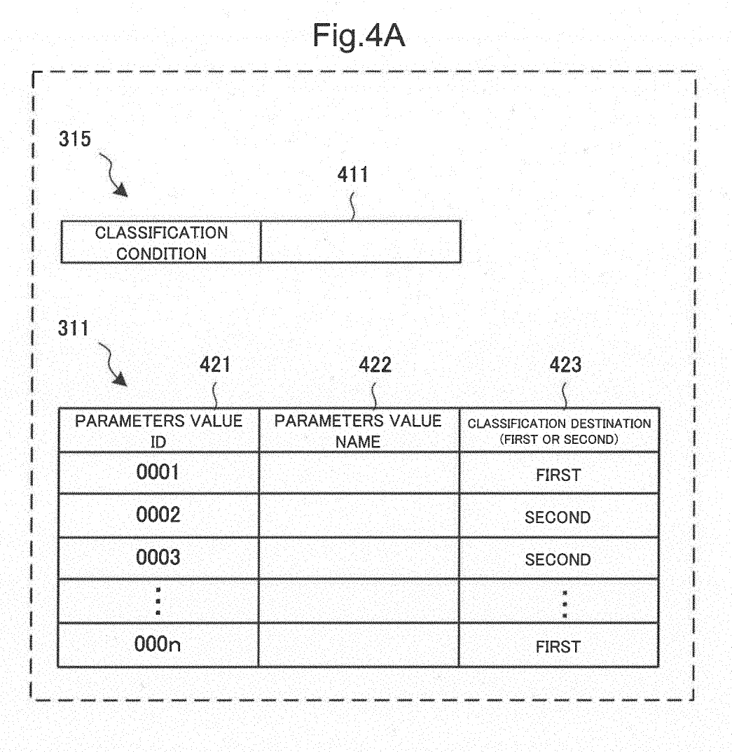

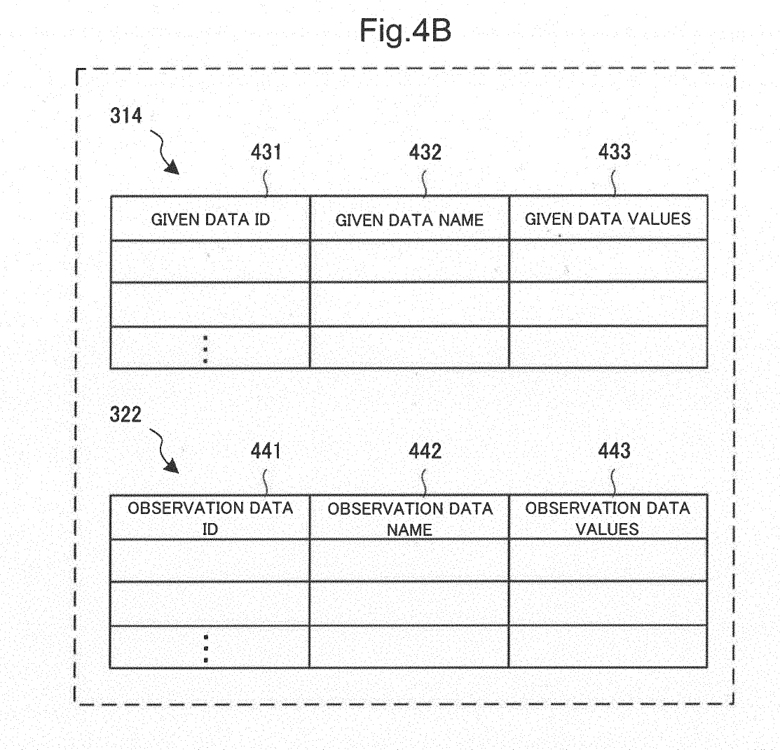

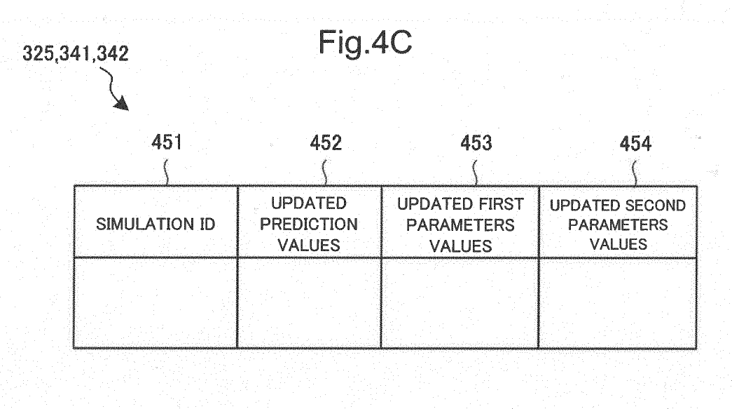

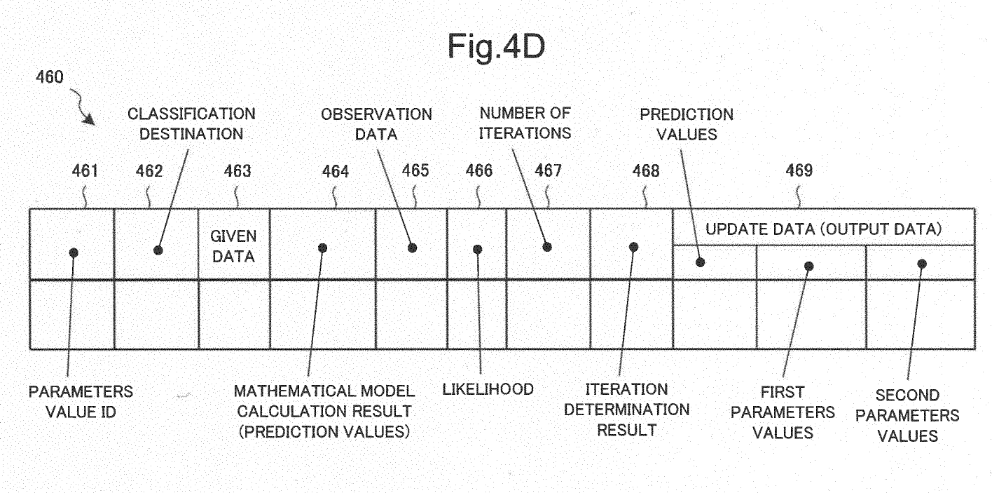

FIG. 4A is a diagram illustrating structures of the parameters storage unit 311 and the classification condition storage unit 315 according to the present example embodiment. The parameters storage unit 311 stores parameters values used in simulation processing. Further, the classification condition storage unit 315 stores a condition for classifying parameter values stored in the parameters storage unit 311 into first parameters values and second parameters values in the parameters classification unit 312. The classification method and the like are as described above.

The parameters storage unit 311 stores a parameters value name 422 and a classification destination (first or second) 423 in association with a parameters value ID 421. The classification condition storage unit 315 stores classification condition data 411.

(Given Data Storage Unit 314 and Observation Data Storage Unit 322)

FIG. 4B is a diagram illustrating structures of the given data storage unit 314 and the observation data storage unit 322 according to the present example embodiment. The given data storage unit 314 stores given data used by the mathematical model calculation unit 323. Further, the observation data storage unit 322 stores observation data used in processing of the likelihood calculation unit 324 calculating a likelihood related to prediction values calculated by the mathematical model calculation unit 323. The observation data is, for example, observation data (may be processed) acquired from an observation satellite or an observation sensor.

The given data storage unit 314 stores a given data name 432 and given data values 433, the two being associated with a given data ID 431. Further, the observation data storage unit 322 stores an observation data name 442 and observation data values 443 in association with an observation data ID 441.

(Updated Prediction Values, and First Parameters and Second Parameters Storage Units)

FIG. 4C is a diagram illustrating a structure of the prediction values-and-second-parameters storage unit 325, the first parameters storage unit 341, or the prediction values-and-second-parameters storage unit 342, according to the present example embodiment. While an example of integrating the respective aforementioned storage units is illustrated in FIG. 4C, the respective units may be independent storage units.

The prediction values-and-second-parameters storage unit 325, the first parameters storage unit 341, or the prediction values-and-second-parameters storage unit 342 stores updated prediction values 452, updated first parameters values 453, and updated second parameters values 454 in association with a simulation ID 451. The storage units store a simulation result when a simulation ends.

(Simulation Processing Table 460)

FIG. 4D is a diagram illustrating a structure of a simulation processing table 460 according to the second example embodiment of the present invention. The simulation processing table 460 is a table used by the simulation device 200 while executing a simulation.

The simulation processing table 460 stores a parameters value ID 461, a classification destination 462 related to parameters values, given data 463, prediction values 464, observation data 465, and a likelihood 466 between the prediction values 464 and the observation data 465. The prediction values 464 are a calculation result based on a mathematical model. Additionally, the simulation processing table 460 includes a number of iterations 467 of a mathematical model calculation, a iteration determination result 468 for ending iteration processing, and update data (output data) 469. The update data (output data) 469 include prediction values, first parameters values, and second parameters values.

<<Hardware Configuration of Simulation Device 200>>

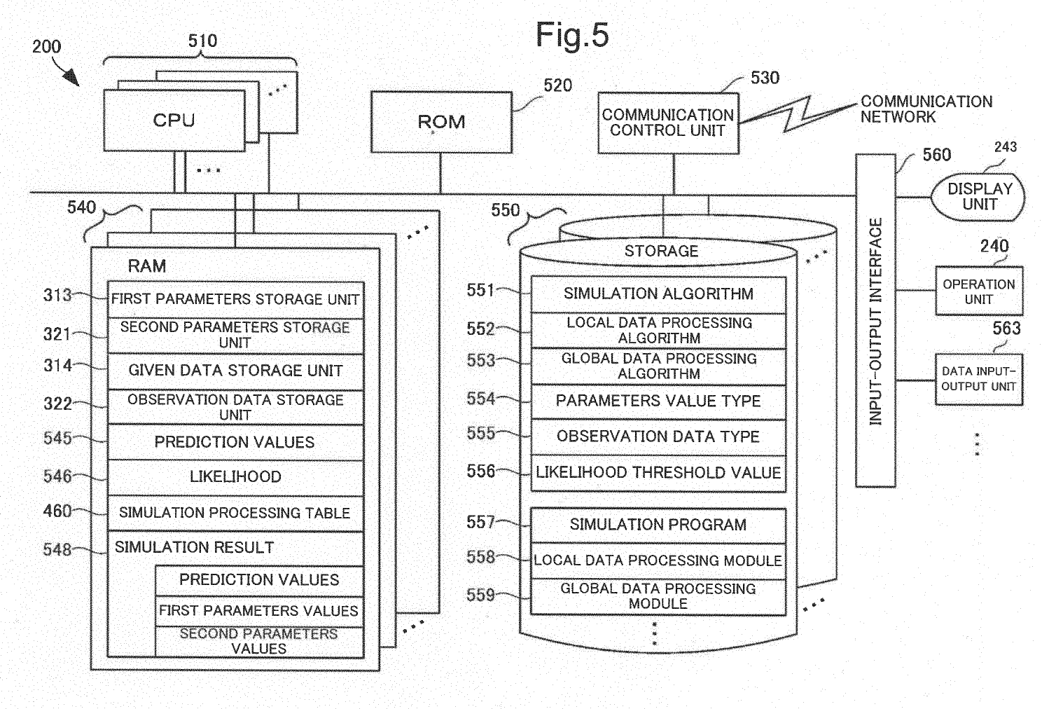

FIG. 5 is a block diagram illustrating a hardware configuration of the simulation device 200 as the information processing device according to the present example embodiment.

In FIG. 5, a central processing unit (CPU) 510 is a processor executing a plurality of arithmetic controls and provides the functional components in the simulation device 200 in FIG. 3 by executing a program. A read only memory (ROM) 520 stores initial data, fixed data for a program or the like, and a program. A communication control unit (communication controller) 530 controls a communication with a communication terminal, a database, and another device, through a communication network.

A random access memory (RAM) 540 includes a plurality of random access memories used by the CPU 510 as work areas for temporal storage. The RAM 540 includes an area storing data for providing the present example embodiment. A first parameters storage unit 313 is an area storing first parameters values as illustrated in FIG. 3. A second parameters storage unit 321 is an area storing second parameters values as illustrated in FIG. 3. A given data storage unit 314 is an area storing given data as illustrated in FIG. 3. An observation data storage unit 322 is an area storing observation data as illustrated in FIG. 3. Prediction values 545 is an area storing prediction values calculated in accordance with a mathematical model. A likelihood 546 is an area storing a likelihood between the prediction values 545 and the observation data. A simulation processing table 460 is an area storing a table used in a case of controlling the simulation processing as illustrated in FIG. 4D. A simulation result 548 is an area storing a simulation result based on a mathematical model. For example, when a simulation ends, the simulation result 548 includes prediction values, first parameters values, and second parameters values at the end of the simulation.

A storage 550 includes a plurality of storages storing a database, various types of parameters, or the following data or program for providing the present example embodiment. A simulation algorithm 551 is an area storing a simulation method according to the present example embodiment. A local data processing algorithm 552 is an area storing a local data processing method according to the present example embodiment. A global data processing algorithm 553 is an area storing a global data processing method according to the present example embodiment. A parameters value type 554 is an area storing types of parameters values used in the present example embodiment. An observation data type 555 is an area storing types of observation data used in the present example embodiment. A likelihood threshold value 556 is an area storing a threshold value in a case of determining a likelihood used in the present example embodiment. The storage 550 stores the following programs. A simulation program 557 is a program controlling simulation processing by the simulation device 200. A local data processing module 558 is a module controlling local data processing by the local data processing unit 320. A global data processing module 559 is a module controlling global data processing by the global data processing unit 310.

An input-output interface 560 interfaces with peripheral equipment. The input-output interface 560 is connected to a display unit 243, an operation unit 240, and a data input-output unit 563.

A program and data related to a general-purpose function and another feasible function that are included in the simulation device 200 are not illustrated in the RAM 540 and the storage 550 in FIG. 5.

<<Simulation Procedure in Simulation Device 200>>

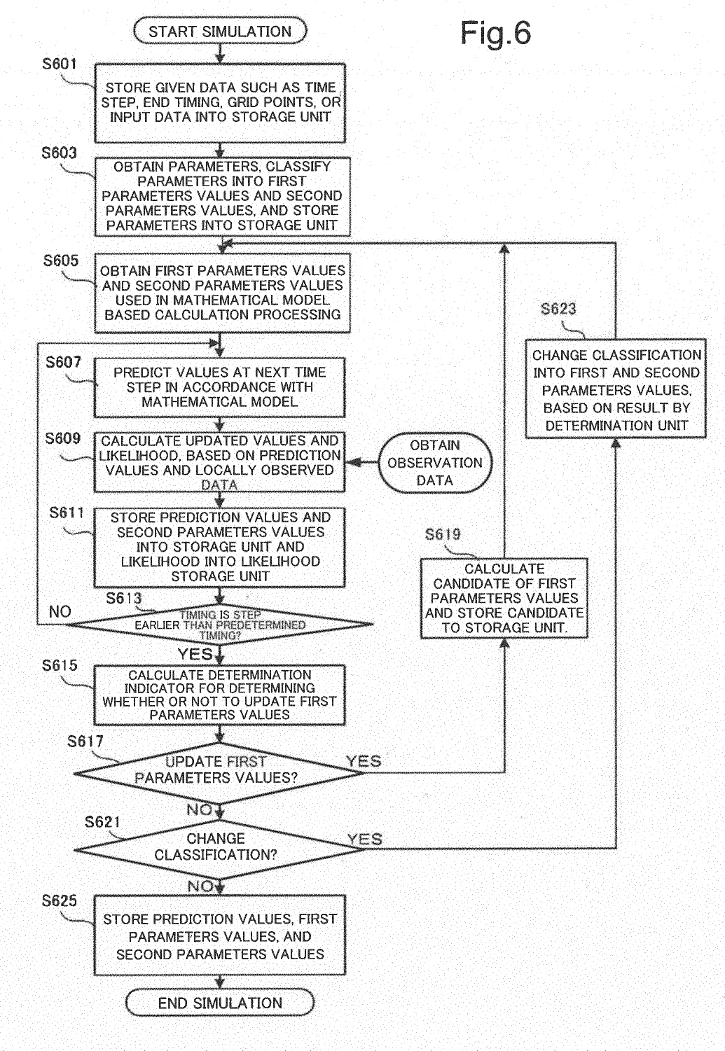

FIG. 6 is a flowchart illustrating a simulation procedure in the simulation device 200 as the information processing device according to the present example embodiment. The CPU 510 in FIG. 5 executes processing shown in the flowchart by use of the RAM 540 and provides the functional components in FIG. 3.

The simulation device 200 starts a simulation. First, the global data processing unit 310 stores given information (e.g. a time step, a predetermined time to end, grid points, and other input data) being a condition necessary for execution of the target simulation into the given data storage unit 314 (Step S601). Next, the parameters classification unit 312 performs classification processing into first parameters values and second parameters values, based on parameters values stored in the parameters storage unit 311 and a classification condition stored in the classification condition storage unit 315. The parameters classification unit 312 stores the parameters values into the first parameters storage unit 313 and the second parameters storage unit 321, respectively (Step S603). When classification into first parameters values and second parameters values has been previously performed and the parameter values have been stored in first parameters storage unit 313 and the second parameters storage unit 321, Step S603 will be omitted.

Next, the local data processing unit 320 first obtains information (first parameters values and second parameters values) used in calculation processing based on a mathematical model stored in the given data storage unit 314, the first parameters storage unit 313, and the second parameters storage unit 321 (Step S605). The mathematical model calculation unit 323 predicts values at a next time step (Step S607). The mathematical model calculation unit 323 executes the processing a plurality of number of times depending on a number of ensembles and a number of parallel calculations (unillustrated) and, thereby, executes ensembles based on Eqn. 3. The likelihood calculation unit 324 calculates updated values of model outputs and a likelihood in accordance with the processing indicated in Eqn. 4 to Eqn. 6, based on the prediction values calculated by the mathematical model calculation unit 323 and observation data stored in the observation data storage unit 322 (Step S609). Then, the likelihood calculation unit 324 stores the updated values and the likelihood into the prediction values-and-second-parameters storage unit 325 and the likelihood storage unit 326, respectively (Step S611).

At this time, a determination of whether a simulation time reaches a predetermined end time is executed (Step S613). When the simulation time does not reach the end time, the processing returns to the calculation based on the mathematical model (Step S607). When the simulation time reaches the end time, the determination unit 331 in the global data update unit 330 calculates a determination indicator for determining whether or not to update the first parameters values (Step S615), and determines whether or not to update the first parameters values (Step S617). When the first parameters values are updated, a candidate of new first parameters values is calculated, and the calculated candidate is stored into the first parameters storage unit 313 (Step S619). Subsequently, the processing returns to the parameters values obtainment for mathematical model calculation (Step S605). When the first parameters values are not updated, the parameters classification unit 312 determines whether or not to change the classification (Step S621). When the classification is changed, the determination unit 331 updates the classification condition, based on the result, and stores the changed first parameters values and second parameters values into the storage units, respectively (Step S623). Subsequently, the processing returns to the processing of obtaining parameters values used in calculation based on the mathematical model (Step S605). When the classification is not changed, the determination unit 331 stores the prediction values and the second parameters values, and the first parameters values into the prediction values-and-second-parameters storage unit 342 and the first parameters storage unit 341 in the data output unit 340, respectively (Step S625) and ends the simulation.

Thus, the present example embodiment is able to provide a technology of performing a simulation with high calculation efficiency, without estimating unsuitable or locally optimum parameters, even when a mathematical model and data for the simulation have uncertainty, and a dimension of parameters to be estimated is high. The present example embodiment is particularly effective when observation data have a temporally and spatially uneven distribution due to an insufficient obtaining period of observation data, missing data, or the like.

The present example embodiment continues update of first parameters values until a variation of the first parameters values for each update and a variation of a consistency degree reach threshold values or less. When the variations do not reach the threshold values after the update is performed a predetermined number of times, the present example embodiment reclassifies the parameters values. Accordingly, the present example embodiment is able to execute a simulation with higher calculation efficiency, without estimating unsuitable or locally optimum parameters, even when a mathematical model and data that are used in the simulation have uncertainty, and a dimension of parameters to be estimated is high.

### Third Example Embodiment

Next, a simulation device as an information processing device according to a third example embodiment of the present invention will be described. Compared with the second example embodiment, the simulation device according to the present example embodiment differs in that a plurality of local data processing units are connected to one global data processing unit. The remaining configuration and operation are similar to those according to the second example embodiment, and therefore same reference signs are given to same configurations and operations, and detailed description thereof will be omitted.

<<Functional Configuration of Simulation Device>>

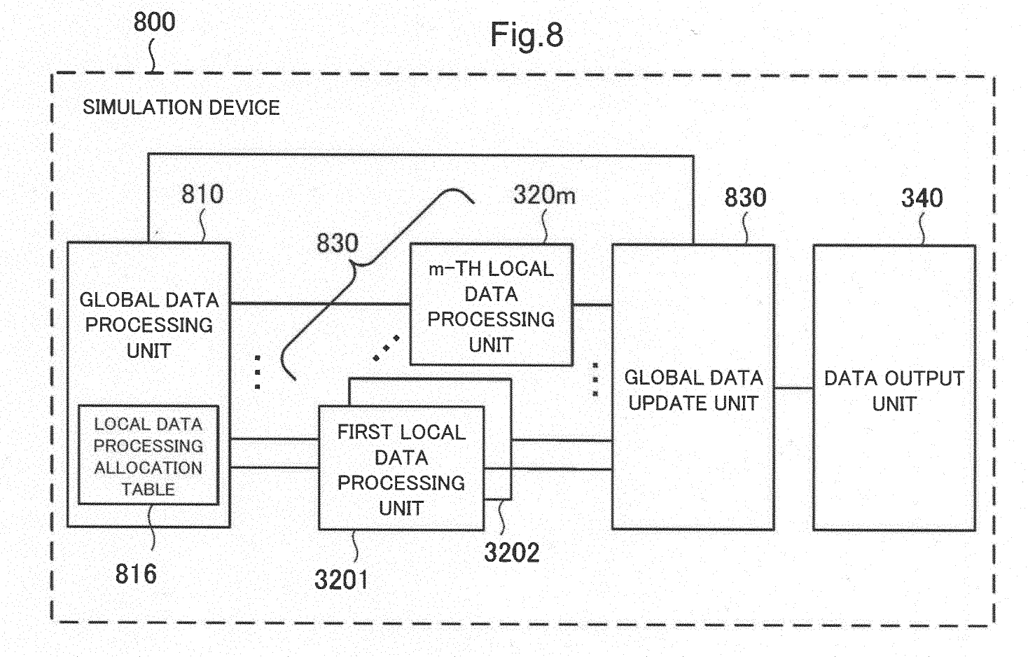

FIG. 8 is a block diagram illustrating a functional configuration of a simulation device 800 as the information processing device according to the present example embodiment. In FIG. 8, a same reference numeral is given to a functional component similar to that in FIG. 3, and redundant description thereof will be omitted.

The simulation device 800 has a configuration independently including m pieces (where m is an integer greater than or equal to 2) of the local data processing units (local data processors) 320 in FIG. 3 for respective target partial areas (denoted as 3201 to 320m). The present example embodiment is applicable to such a case that an entire simulation target area is wide or parameters are identical at every plurality of blocks. It is assumed that the partial area is arranged at each grid point, or at each set (block) of at least two or more grid points or at each target local area, after the entire simulation target area is divided into the respective local areas and is further grid-divided.

A global data processing unit (global data processor) 810 includes a local data processing allocation table 816 providing given data, first parameters values, and second parameters values for mathematical model calculation units in a plurality of local data processing units 3201 to 320m. The simulation device 800 includes a plurality of local data processing units (local data processors) 320k (k=1 to m, where m is an integer greater than or equal to 2), one first parameters storage unit 313 (FIG. 3) and one given data storage unit 314 (FIG. 3). Every local data processing unit 320k inputs a common value. On the other hand, each local data processing unit 320k includes one second parameters storage unit 321 (FIG. 3). Each second parameters storage unit 321 stores common or different values.

Then, the global data update unit (global data updater) 830 aggregates likelihoods, updated prediction values, and updated second parameters values stored in the plurality of local data processing units (local data processors) 3201 to 320m, and further controls update of first parameters values and update of classification of parameters values.

(Local Data Processing Allocation Table 816)

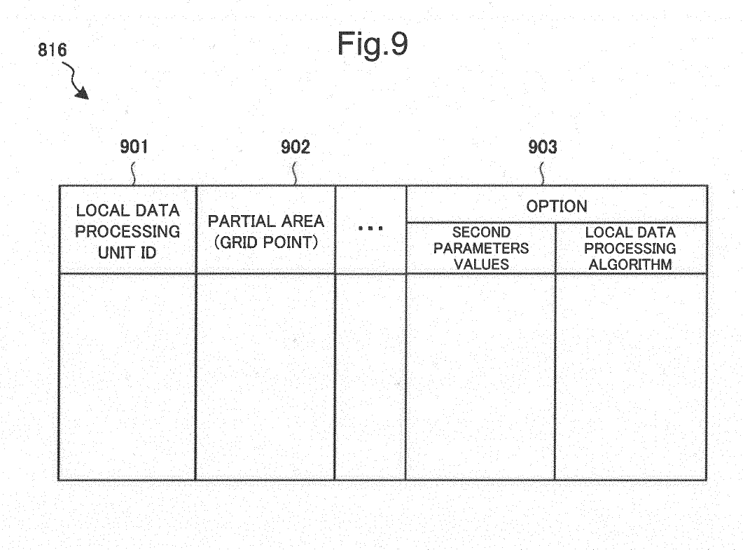

FIG. 9 is a diagram illustrating a structure of the local data processing allocation table 816 according to the present example embodiment. The local data processing allocation table 816 is used for managing information provided for a plurality of local data processing units 3201 to 320m.

The local data processing allocation table 816 stores a partial area (or a grid point) 902 processed by each local data processing unit in association with a local data processing unit ID 901. The local data processing allocation table 816 may store, as an option 903, information for setting second parameters values to different values between local data processing units or setting an algorithm for local data processing to different methods between local data processing units.

The present example embodiment is able to perform processing in parallel by a plurality of local data processing units when an entire simulation target area is wide or a simulation is precisely performed with a small area. Accordingly, the present example embodiment is able to perform a simulation with higher calculation efficiency, without estimating unsuitable or locally optimum parameters, even when a mathematical model and data that are used in the simulation have uncertainty, and also a dimension of parameters to be estimated is high.

### Fourth Example Embodiment

Next, a simulation device as an information processing device according to a fourth example embodiment of the present invention will be described. Compared with the second and third example embodiments, the simulation device according to the present example embodiment differs in storing a simulation processing history and setting parameters, initial values, and an algorithm at a start of a new simulation, based on the history. The remaining configuration and operation are similar to those according to the second and third example embodiments, and therefore same reference signs are given to same configurations and operations, and detailed description thereof will be omitted.

<<Functional Configuration of Simulation Device 1000>>

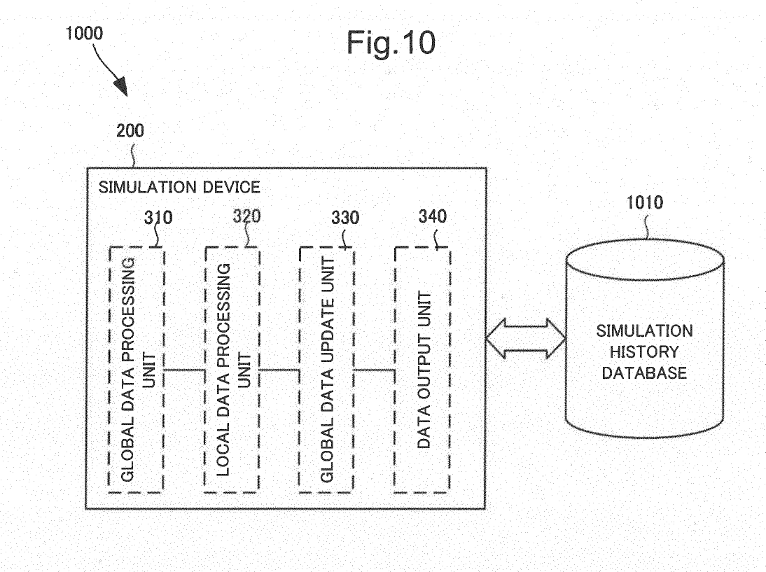

FIG. 10 is a block diagram illustrating a functional configuration of a simulation device 1000 as the information processing device according to the present example embodiment. In FIG. 10, a same reference numeral is given to a component similar to that in FIG. 3, and redundant description thereof will be omitted.

In addition to the simulation device 200 in FIG. 3, the simulation device 1000 includes a simulation history database 1010 storing a history of simulation results by the simulation device 200, and based on the history, storing information being a basis of setting initial values of simulation processing to suitable values. The simulation device 200 may include the simulation history database 1010.

(Simulation History Database 1010)

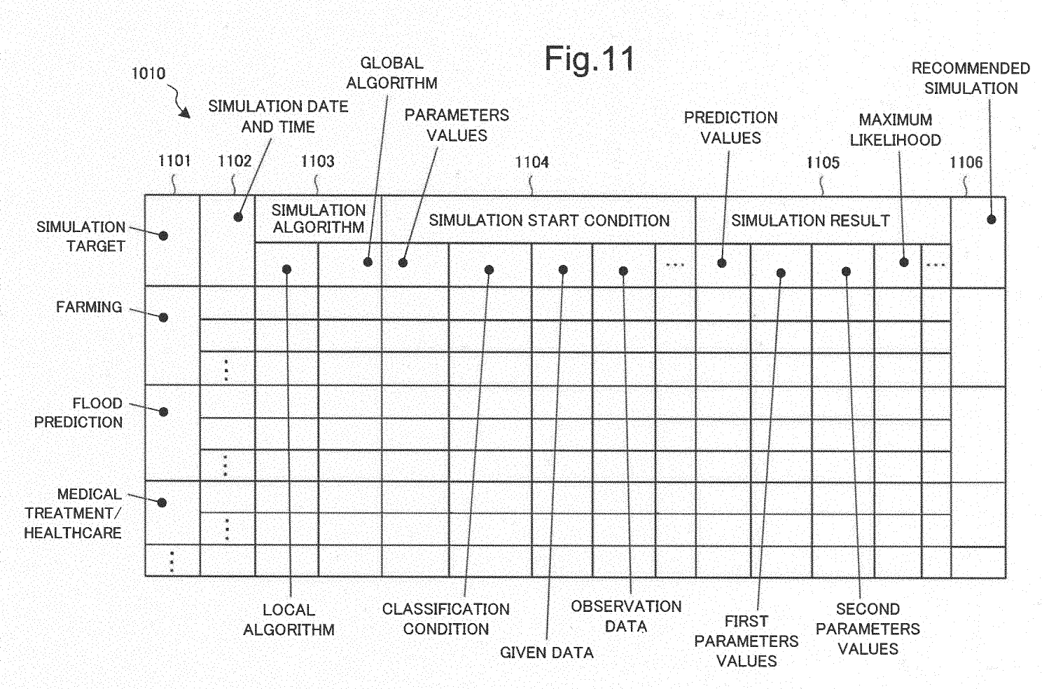

FIG. 11 is a diagram illustrating a structure of the simulation history database 1010 according to the present example embodiment.

The simulation history database 1010 stores a history of a plurality of simulations associated with each simulation target 1101. A history of a simulation includes a simulation date and time 1102, a simulation algorithm 1103 being used, a simulation start condition 1104, and a simulation result 1105. Then, the simulation history database 1010 stores a recommended simulation 1106 based on the history of the simulations.

The simulation algorithm 1103 includes a local algorithm and a global algorithm. Further, the simulation start condition 1104 includes parameters values, a classification condition, given data, and observation data. Further, the simulation result 1105 includes prediction values, first parameters values, and second parameters values.

The present example embodiment stores a history of simulation results and sets initial values of simulation processing to suitable values by referring to the history, and therefore is able to more rapidly acquire a more suitable simulation result.

### Fifth Example Embodiment

Next, a simulation device as an information processing device according to a fifth example embodiment of the present invention will be described. Compared with the second to fourth example embodiments, the simulation device according to the present example embodiment differs in applying the simulation processing to a more specific farming prediction. The remaining configuration and operation are similar to those according to the second to fourth example embodiments, and therefore same reference signs are given to same configurations and operations, and detailed description thereof will be omitted.

<<Information Processing System>>

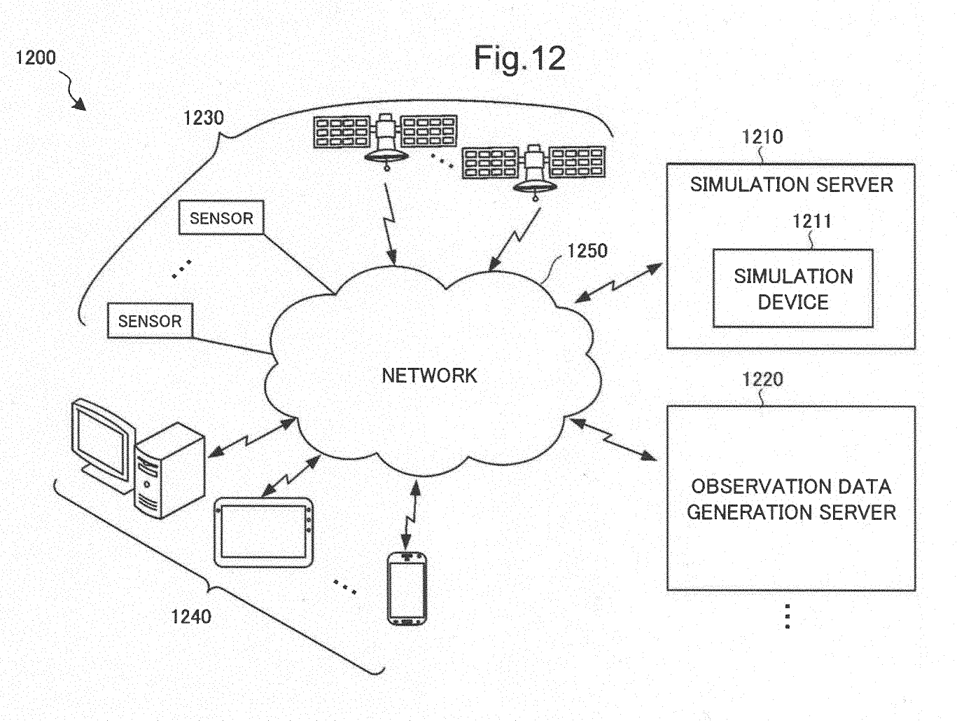

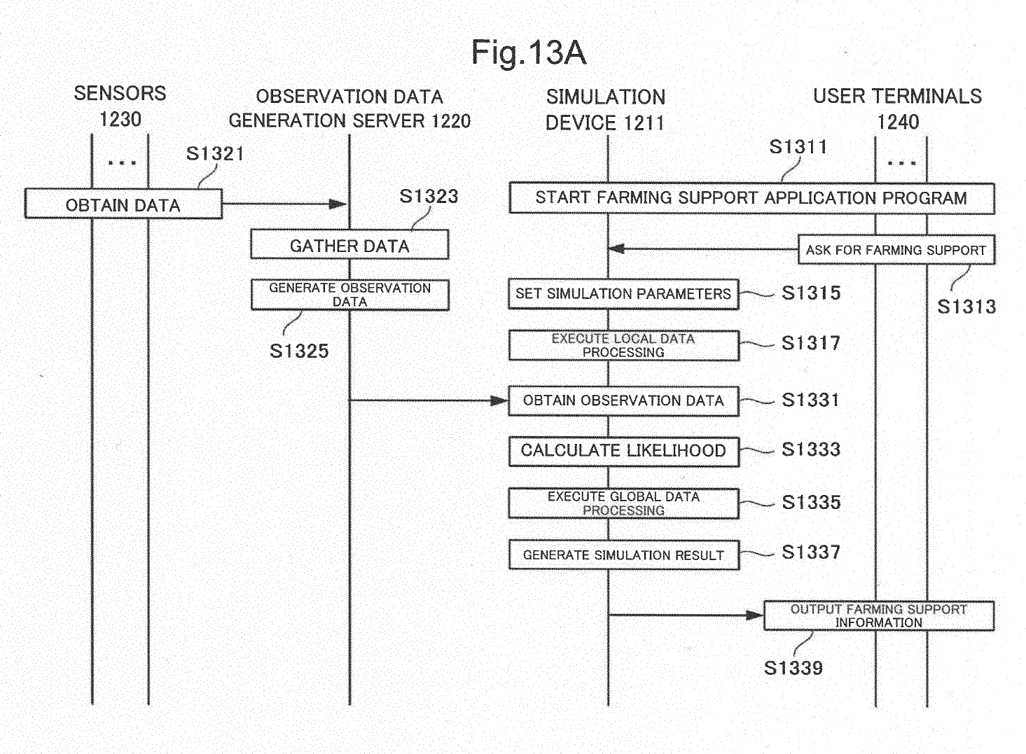

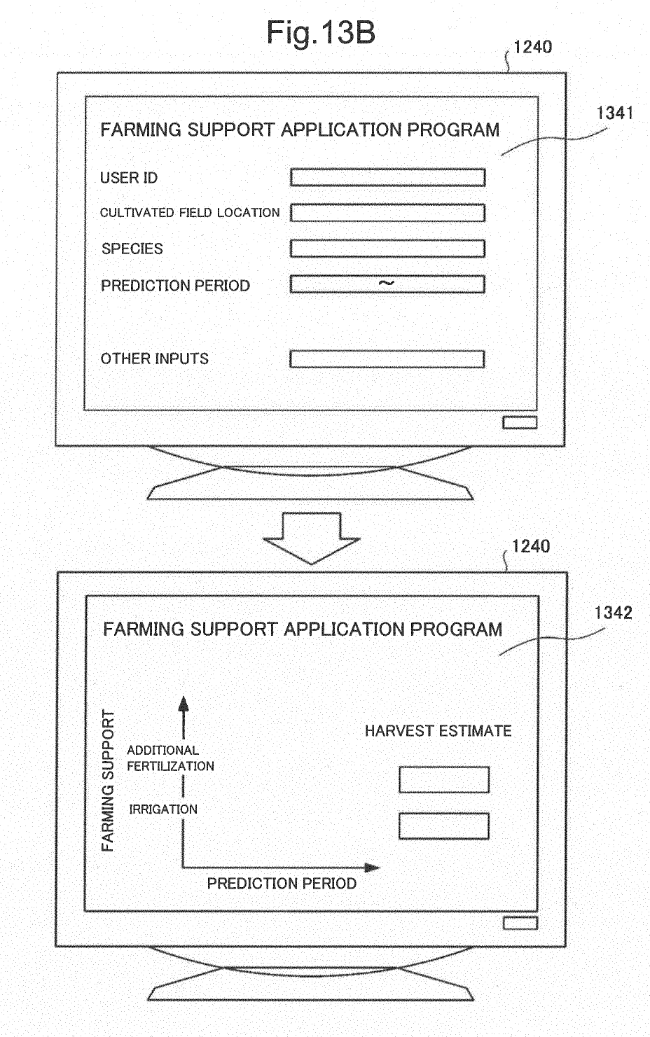

A configuration and an operation of an information processing system including the simulation device according to the present example embodiment will be described with reference to FIGS. 12, 13A, and 13B.

<<System Configuration>>

FIG. 12 is a block diagram illustrating a configuration of an information processing system 1200 including a simulation device 1211 as the information processing device according to the present example embodiment.

The information processing system 1200 includes the simulation device 1211 according to the present example embodiment, an observation data generation server 1220, satellites and sensors 1230 detecting observation data, and a user terminal 1240 used by a user receiving farming support. These components are connected with each other through a communication network 1250. A simulation server 1210 includes the simulation device 1211.

Observation data detected by the satellites and sensors 1230 are gathered by the observation data generation server 1220. The observation data generation server 1220 generates observation data usable in the simulation device 1211. Further, in response to a request related to farming support, the simulation device 1211 generates farming support information by use of the observation data generated by the observation data generation server 1220 and provides the farming support information for the user terminal 1240. The user terminal 1240 obtains the request.

(Operation Sequence)

FIG. 13A is a sequence diagram illustrating an operation sequence of the information processing system 1200 according to the present example embodiment.

In Step S1311, a farming support application program is started between the simulation device 1211 on the simulation server 1210 and the user terminal 1240. When receiving a request for farming support from the user terminal 1240 in Step S1313, the simulation device 1211 sets simulation parameters in response to the request in Step S1315. For example, the simulation parameters include farming environment parameters, a classification condition, given data, and observation data. Then, in Step S1317, the simulation device 1211 executes local data processing by the local data processing unit.

On the other hand, the observation data generation server 1220 gathers observation data obtained by the sensors 1230 and the like in Step S1321 (Step S1323). Then, in Step S1325, the observation data generation server 1220 generates observation data used by the simulation device 1211, based on the gathered observation data.

The simulation device 1211 obtains the observation data generated by the observation data generation server 1220 in Step S1331. In Step S1333, the simulation device 1211 calculates a likelihood between the prediction values calculated in the local data processing and the observation data. Then, in Step S1335, the simulation device 1211 executes global data processing, based on the prediction values and the likelihood.

The simulation device 1211 iterates Steps S1317 to S1335 and subsequently generates a simulation result in Step S1337. Then, the simulation device 1211 generates farming support information based on the simulation result and returns the generated farming support information to the user terminal 1240. In Step S1339, the user terminal 1240 outputs the farming support information.

<<Display and Operation at User Terminal 1240>>

FIG. 13B is a diagram illustrating an outline of display and operation in the user terminal 1240 according to the present example embodiment. FIG. 13B illustrates a farming support input screen 1341 and a farming support output screen 1342 that are controlled by a display-and-operation unit included in the user terminal 1240.

The farming support input screen 1341 includes entry fields for a user ID for identifying a user, cultivated field information including a cultivated field location being a farming support target, a species to be grown, a prediction period, and the like. A user is not required to enter all the items, and does not need to enter information that may be set by the simulation device 1211.

On the other hand, the farming support output screen 1342 displayed after a simulation includes, as a simulation result, information such as additional fertilization and irrigation as farming support during a prediction period, or suitable values such as a harvest estimate and the like. By such a farming support output, suitable farming support information can be rapidly provided with an agriculture-related organization and a farm as targets.

<<Functional Configuration of Simulation Device 1211>>

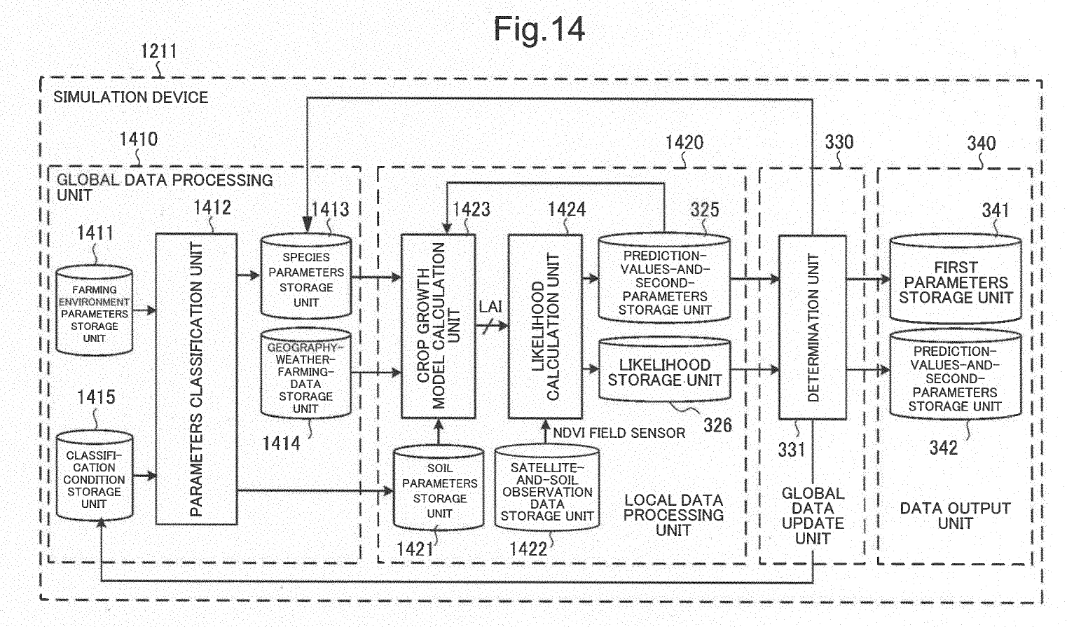

FIG. 14 is a block diagram illustrating a functional configuration of the simulation device 1211 as the information processing device according to the present example embodiment. In FIG. 14, a same reference numeral is given to a functional component similar to that in FIG. 3, and redundant description thereof will be omitted.

In FIG. 14, a local data processing unit (local data processor) 1420 in the simulation device 1211 includes a configuration of specifically applying a crop growth model calculation unit (crop growth model calculator) 1423 to the mathematical model calculation unit 323 according to the second example embodiment. A geography-weather-farming-data storage unit 1414 in the global data processing unit (global data processor) 1410 stores a geography, weather, and farming data such as irrigation and fertilization as given data required for simulation in the crop growth model calculation unit 1423. Further, a farming environment parameters storage unit 1411 stores as parameters values parameters characterizing a soil, parameters characterizing a crop, and the like. With regard to these farming environment parameters, as an example of a result already classified by the parameters classification unit (parameters classifier) 1412, based on the classification condition storage unit 1415, species parameters corresponding to first parameters values are stored in a species parameters storage unit 1413, and soil parameters corresponding to second parameters values are stored in a soil parameters storage unit 1421. Additionally, as specific observation data, remote sensing data by a satellite or an aircraft, the data representing a growth state of a crop, a camera image, a soil water content and a soil temperature by a field sensor installed in the soil, and the like are stored in a satellite-and-soil observation data storage unit 1422, according to the present example embodiment. A configuration of the remaining part is similar to that of the simulation device 200 described in the second example embodiment, and therefore description thereof will be omitted.

As observation data indicating a growth state of a crop, a normalized difference vegetation index (NDVI) generally used as a vegetation index may be used. The value may be calculated from reflectances of two bands being a visible-red band and a near-infrared band. Additionally, a leaf area index (LAI) is used as a variable used by the crop growth model calculation unit 1423, according to the present example embodiment. LAI is known to be correlated with NDVI. Such LAI may be calculated by inputting a geography, weather, a crop, soil parameters, and the like to the crop growth model calculation unit 1423 from the geography-weather-farming-data storage unit 1414, the species parameters storage unit 1413, and the soil parameters storage unit 1421. However, the present example embodiment is not limited to use of the aforementioned quantities as observation data and variables.

For example, NDVI as observation data may be calculated from data acquired from the MODIS (Terra AQUA/MODIS) being a sensor equipped on the Terra satellite or the AQUA satellite. MODIS is an abbreviation for MODerate resolution Imaging Spectroradiometer. Specifically, reflected light intensity data with respect to the sunlight at the visible-red band [wavelength: 0.58 micrometer (μm) to 0.86 μm] and the near-infrared band (wavelength: 0.725 μm to 1.100 μm) by the Terra AQUA/MODIS are available. While the data are basically obtainable on a daily basis, a spatial resolution on the ground is approximately 250 m, which is low. Further, data acquired from the LANDSAT satellite, the PLEIADES satellite, the ASNARO satellite, and the like may also be used. ASNARO is an abbreviation for Advanced Satellite with New system Architecture for Observation. Wavelength ranges obtained from the satellites are almost identical. However, a ground resolution and an obtainment frequency are approximately 30 m at intervals of 8 to 16 days for the LANDSAT satellite and approximately 2 m at intervals of two to three days for the PLEIADES satellite and the ASNARO satellite. A camera image has only to be an image including the aforementioned visible-red band and the near-infrared band. However, a wavelength range obtained as observation data does not necessarily be limited to the bands.

As described above, the present example embodiment differs from the second example embodiment in the crop growth model calculation unit 1423, input given data, and estimated parameters values. A configuration and an operation of the remaining part are similar. As an example of a crop growth model, the Decision Support System for Agrotechnology Transfer (DSSAT), the Agricultural Production Systems siMulator (APSIM), and the WOrld FOod STudies (WOFOST) may be used. The crop growth models are examples, and suitable models are developed for a variety of crops in various regions, respectively. However, many models have equivalent basic structures and differ only in definitions of input and output data, and types of parameters. Accordingly, the models may be used where suitable without being limited, according to the present example embodiment.

(Simulation Processing Table 1560)

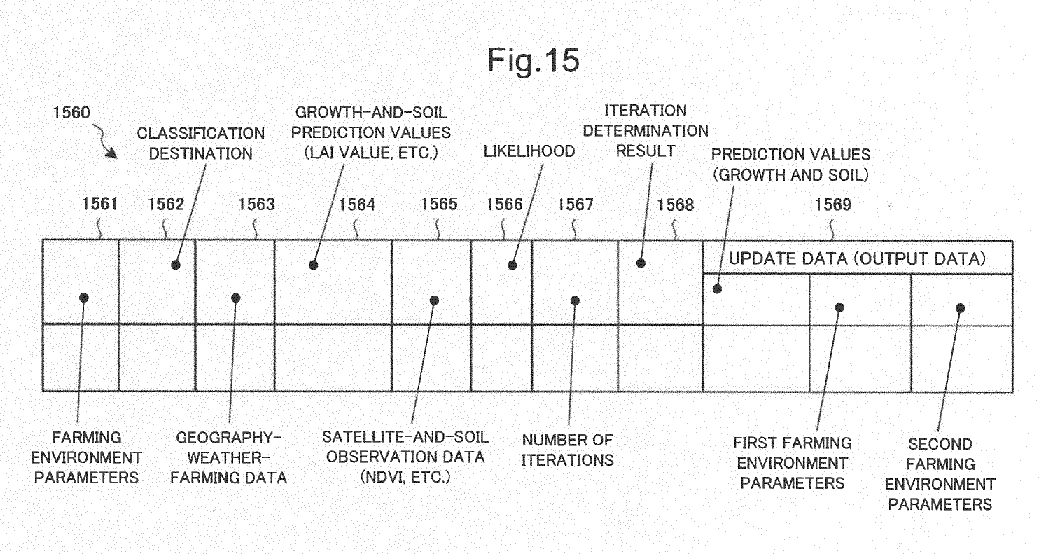

FIG. 15 is a diagram illustrating a structure of a simulation processing table 1560 according to the present example embodiment. The simulation processing table 1560 is a table used by the simulation device 1211 while executing a simulation.

The simulation processing table 1560 stores farming environment parameters 1561 as parameters values, a classification destination 1562 related to the farming environment parameters, geography-weather-farming data 1563 as given data, and growth-and-soil prediction values 1564 being a crop growth model calculation result. Further, the simulation processing table 1560 stores satellite-and-soil observation data 1565, and a likelihood 1566 between the growth-and-soil prediction values 1564 and the satellite-and-soil observation data 1565. Additionally, the simulation processing table 1560 stores a number of iterations 1567 of crop growth model calculation, a iteration determination result 1568 for ending iteration, and update data (output data) 1569. The update data (output data) 1569 include growth-and-soil prediction values, first farming environment parameters, and second farming environment parameters.

(Classification Example of Farming Environment Parameters 1561)

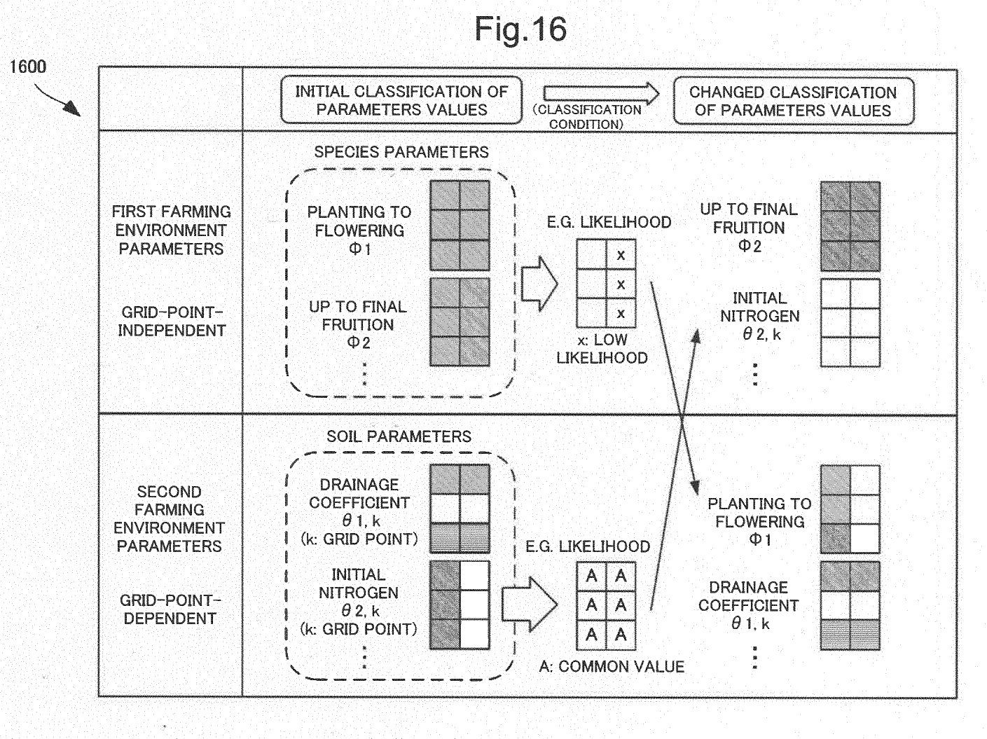

FIG. 16 is a diagram illustrating a classification example 1600 of farming environment parameters 1561 as parameters values according to the present example embodiment. A specific example of soil parameters characterizing a soil, the parameters being described above as parameters values, a specific example of species parameters characterizing a crop and a species thereof, and an initial classification example will be described with reference to FIG. 16. Note that parameters values vary by crop models. A typical representative will be presented below.

Examples of estimated soil parameters include a drainage coefficient indicating drain-ability for water drained from a soil, a saturation value and a minimum value related to a soil water content, and an initial inorganic nitrogen content (fertility). The values depend on non-uniformity in a soil. The values may take different values at a spot several ten meters far from a calculation target. Accordingly, first, based on knowledge and experience of such an agriculture field, it is considered not to assume that the values at respective calculation grid points are common (i.e. classified as second farming environment parameters as second parameters values).

On the other hand, examples of estimated species parameters include values related to so-called phenology such as a period from seeding or planting to flowering, a period up to initial fruition, and a period up to final fruition. For the same crop and species, the aforementioned values basically should be constants. First, it is considered to assume that the values are common at respective calculation grid points (i.e. classified as first farming environment parameters as first parameters values).

However, for example, a behavior of either soil water or soil nitrogen may have high spatial uniformity. Additionally, timings of flowering and fruition depend on a stress state (e.g. an amount of water or fertilizer) of a crop in a cultivation environment, and therefore even the same species may exhibit different behaviors.

Accordingly, FIG. 16 illustrates an example of changing the aforementioned classification of parameters values.

First, it is assumed that, as described above, classification is set based on knowledge and experience of a target field, and a property of a numerical calculation model, at an initial classification stage of farming environment parameters. Then, when processing is executed in accordance with a flowchart similar to that according to the second example embodiment (see FIG. 6), a likelihood and second parameters values at each grid point are calculated. For example, it is assumed that, even when species parameters independent of grid points (i.e. classified as first parameters values taking constant at every grid point) are updated a predetermined number of times, a likelihood at a specific grid point decreases compared with other points, as illustrated in FIG. 16. In such a case, the classification as first parameters values under the assumption that the parameters be constant at every grid point may be unsuitable. Accordingly, by changing at least one of the species parameters (planting to flowering φ1 in the diagram) to second parameters values, estimation dependent on grid points is performed.

Further, estimated values of the soil parameters dependent on grid points (i.e. classified as second parameters values taking different values at respective grid points) may become a determination condition. When at least one of the parameters (initial nitrogen θ_{2,k} in the diagram) is estimated to be constant at every grid point in a predetermined range, it is considered that the parameters may inherently be constant at every grid point (i.e. dealt as first parameters values). Accordingly, changing the parameters to first parameters values and assuming estimation independent of grid points leads to reduction in a dimension (i.e. a calculation resource) in estimation processing of second parameters values.

As described above, classification may be changed based on a likelihood and estimated second parameters values. The changed and added classification conditions at the time are stored into the classification condition storage unit. The above-described classification change is an exemplification and is not limited.

Then, species parameters and soil parameters in an actual environment are estimated based on the model and observation data, and a result with a finally highest consistency degree (i.e. a highest likelihood) is stored in the first parameters storage unit 341 and the prediction values-and-second-parameters storage unit 342 in the data output unit 340.

In the case of agriculture (outdoor cultivation in particular), a crop is grown once a year or at most several times a year; and conditions required for simulation, such as a soil and a crop species, are diverse and numerous, and therefore are often not deterministically acquired. Accordingly, for example, the estimated parameters may be used at an initial stage of a start of cultivation in a following year in a case that observation data indicating a growth state of a crop are insufficient. Further, parameters related to a certain region and a certain crop are accumulated, and therefore are useful in expansion to other regions and crops.

While the fifth example embodiment is an example embodiment in a case that the mathematical model calculation unit 323 according to the second example embodiment becomes the crop growth model calculation unit 1423, and observation data are data indicating a growth state of a crop, the above is strictly an exemplification and does not limit the present invention. The data may be suitably selected depending on an applied target.

The present example embodiment is able to rapidly provide suitable farming support information with an agriculture-related organization and a farm as targets, by performing a simulation related to a crop raising (growth).

### Sixth Example Embodiment

Next, a simulation device as an information processing device according to a sixth example embodiment of the present invention will be described. Compared with the second to fifth example embodiments, the simulation device according to the present example embodiment differs in applying the simulation processing to a specific flood prediction. The remaining configuration and operation are similar to those according to the second example embodiment, and therefore a same reference signs are given to same configurations and operations, and detailed description thereof will be omitted.

<<Functional Configuration of Simulation Device>>

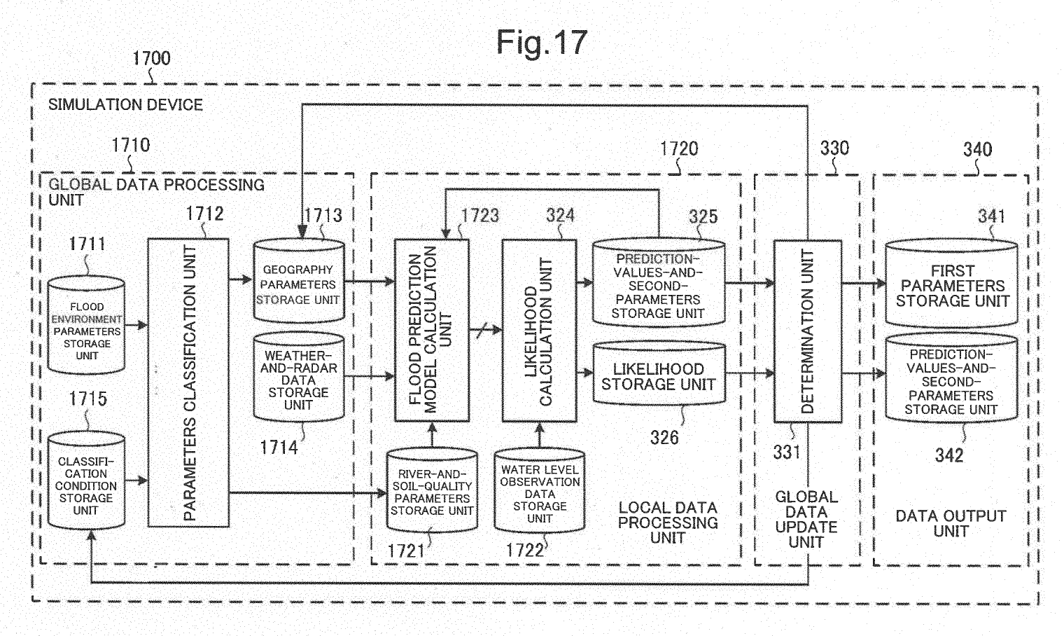

FIG. 17 is a block diagram illustrating a functional configuration of a simulation device 1700 as the information processing device according to the present example embodiment. In FIG. 17, a same reference numeral is given to a functional component similar to that in FIG. 3, and redundant description thereof will be omitted.

In the simulation device 1700 in FIG. 17, a local data processing unit (local data processor) 1720 has a configuration of specifically applying a flood prediction model calculation unit (flood prediction model calculator) 1723 to the mathematical model calculation unit 323 in the simulation device 200 according to the second example embodiment. In a global data processing unit (global data processor) 1710, a weather-and-radar data storage unit 1714 stores general weather information, high-spatiotemporal-resolution precipitation data by a radar, and the like, as given data required for simulation in the flood prediction model calculation unit 1723. Further, a flood environment parameters storage unit 1711 stores, as parameters values, parameters characterizing a geography, parameters characterizing a river and a soil quality, and the like. With regard to these flood environment parameters, as an example of a result already classified by a parameters classification unit (parameters classifier) 1712, based on a classification condition storage unit 1715. Geography parameters corresponding to first parameters values are stored in a geography parameters storage unit 1713. River-and-soil-quality parameters corresponding to second parameters values are stored in a river-and-soil-quality parameters storage unit 1721. Additionally, as specific observation data, water level data indicating a water level of a river, and the like are stored in a water level observation data storage unit 1722 in the present example embodiment. A configuration of the remaining part is similar to that of the simulation device 200 described in the second example embodiment, and therefore description thereof will be omitted.

A flood prediction model according to the present example embodiment is a complex model mainly assuming a distribution-type model obtained by discretizing a basin of a target river in a grid-like manner, and including a tank model (storage function model) considering permeation and advection of water also in a vertical direction. Examples of geography parameters being first parameters values include an inclination and a ratio of an inflow by rainfall for each divided region. On the other hand, examples of the river-and-soil-quality parameters being second parameters values include a local width of a river and coefficients indicating permeation and perviousness of water into a soil. The parameters values may be updated based on a likelihood between the parameters and water level data being observation data, similarly to the second example embodiment of the present invention, and classification thereof may also be changed. However, the model and the parameters are exemplifications and do not limit the present example embodiment.

(Simulation Processing Table 1860)

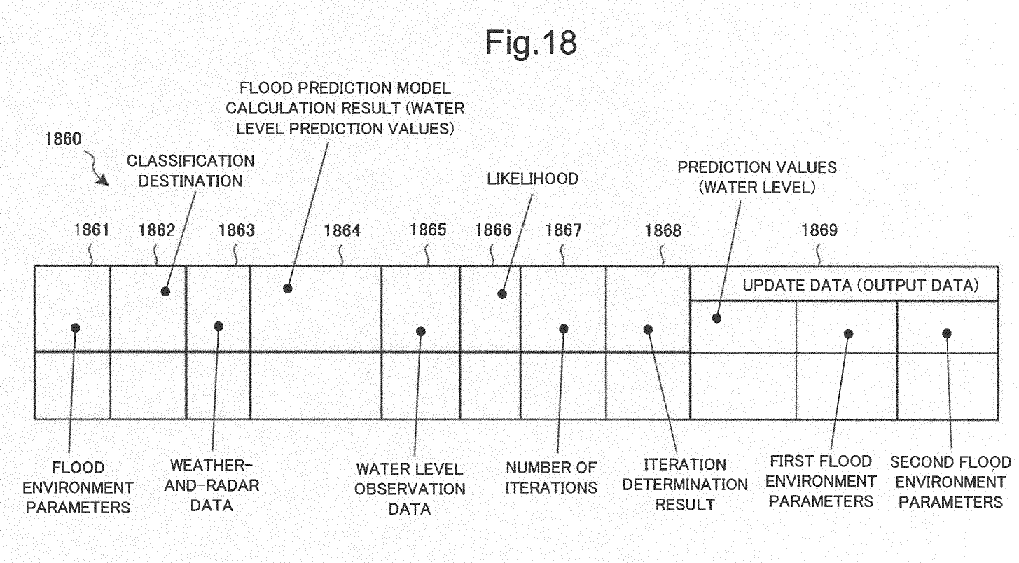

FIG. 18 is a diagram illustrating a structure of a simulation processing table 1860 according to the present example embodiment. The simulation processing table 1860 is a table used by the simulation device 1700 while executing a simulation.

The simulation processing table 1860 stores flood environment parameters 1861 as parameters values, a classification destination 1862 of the flood environment parameters, and weather-and-radar data 1863 as given data. Further, the simulation processing table 1860 includes water level prediction values 1864 being a flood prediction model calculation result, water level observation data 1865, and a likelihood 1866 between the water level prediction values 1864 and the water level observation data 1865. Additionally, the simulation processing table 1860 includes a number of iterations 1867 in a flood prediction model calculation, a iteration determination result 1868 indicating a condition to end iteration, and update data (output data) 1869. The update data (output data) 1869 include water level prediction values, first flood environment parameters, and second flood environment parameters.

The present example embodiment is able to promptly provide suitable monitoring and prediction information of a flood hazard by performing a flood prediction simulation.

### Seventh Example Embodiment

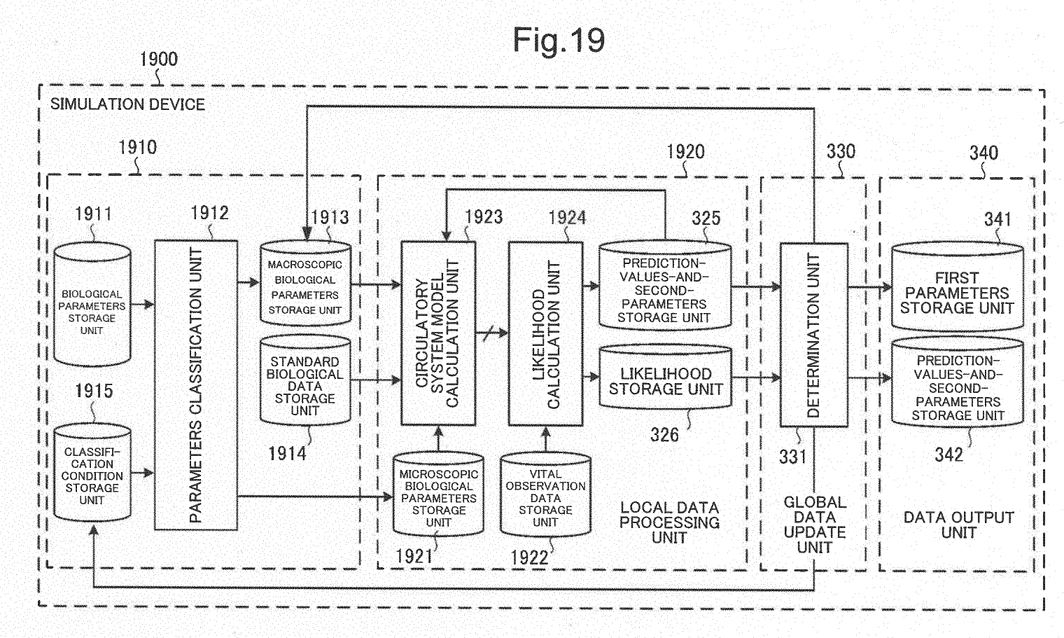

Next, a simulation device as an information processing device according to a seventh example embodiment of the present invention will be described by use of FIG. 19. Compared with the second example embodiment, the simulation device according to the present example embodiment differs in applying the simulation processing to more specific medical treatment or healthcare. The remaining configuration and operation are similar to those according to the second example embodiment, and therefore a same reference signs are given to same configurations and operations, and detailed description thereof will be omitted.

<<Functional Configuration of Simulation Device>>

FIG. 19 is a block diagram illustrating a functional configuration of a simulation device 1900 as the information processing device according to the present example embodiment. In FIG. 19, a same reference numeral is given to a functional component similar to that in FIG. 3, and redundant description thereof will be omitted.

A local data processing unit (local data processors) 1920 in the simulation device 1900 in FIG. 19 has a configuration of specifically applying a circulatory system model calculation unit (circulatory system model calculator) 1923 to the mathematical model calculation unit 323 in the simulation device 200 according to the second example embodiment. A standard biological data storage unit 1914 in a global data processing unit (global data processor) 1910 stores standard biological data such as a structure and a dimension of a living body, and the like, as given data required for simulation executed by the circulatory system model calculation unit 1923. Further, a biological parameters storage unit 1911 stores, as parameters values, parameters representing a macroscopic or microscopic in vivo characteristic, and the like. With regard to these biological parameters, as an example of a result already classified by a parameters classification unit (parameters classifier) 1912, based on a classification condition storage unit 1915. Macroscopic biological parameters corresponding to first parameters values are stored in a macroscopic biological parameters storage unit 1913. Microscopic biological parameters corresponding to second parameters values are stored in a microscopic biological parameters storage unit 1921. Additionally, as specific observation data, so-called vital (living body) data such as a blood pressure and a heart rate, and the like are stored in a vital observation data storage unit 1922 in the present example embodiment. A configuration of the remaining part is similar to that of the simulation device 200 described in the second example embodiment. Accordingly, description thereof will be omitted here.

A circulatory system model according to the present example embodiment is mainly assumed as modeling of a target human body, a blood vessel in particular, and modeling by combining, at a multi-scale, results with different roles, importance, and scales, from a microscopic capillary to a vein, and further to an artery and the like. Further, the model is not limited to a mechanical model and includes a model equivalently reproducing a function and a model combining the two. Examples of parameters indicating macroscopic in vivo characteristics being first parameters values include a blood inflow and an average hardness of a blood vessel that are dependent on individual difference and age. On the other hand, examples of parameters indicating microscopic in vivo characteristics being second parameters values include a thickness and a degree of infarction of a blood vessel that are dependent on a part in a living body, and a degree of hardening of a local blood vessel. The parameters values may be updated based on a likelihood between the parameters and vital data being observation data, similarly to the second and fourth example embodiments of the present invention, and classification thereof may also be changed. However, the model and the parameters are exemplifications and do not limit the present example embodiment.

(Simulation Processing Table 2060)

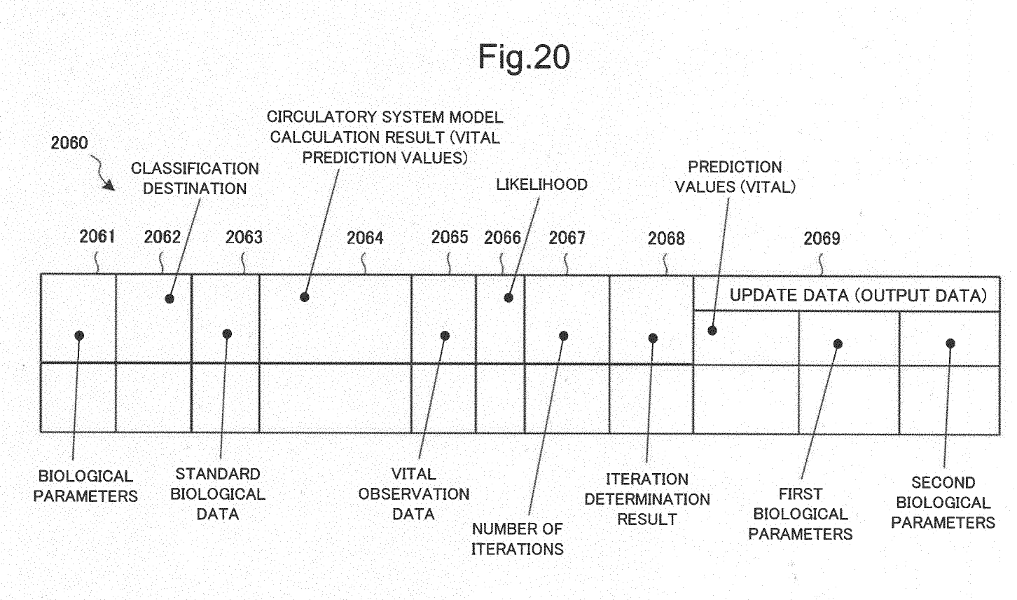

FIG. 20 is a diagram illustrating a structure of a simulation processing table 2060 according to the present example embodiment. The simulation processing table 2060 is a table used by the simulation device 1900 while executing a simulation.

The simulation processing table 2060 includes biological parameters 2061 as parameters values, a classification destination 2062 of the biological parameters, and standard biological data 2063 as given data. Further, the simulation processing table 2060 includes vital prediction values 2064 being a circulatory system model calculation result, vital observation data 2065, and a likelihood 2066 between the vital prediction values 2064 and the vital observation data 2065. Additionally, the simulation processing table 2060 includes a number of iterations 2067 in a circulatory system model calculation, a iteration determination result 2068 for ending iteration, and update data (output data) 2069. The update data (output data) 2069 include vital prediction values, first biological parameters, and second biological parameters.

The present example embodiment is able to rapidly provide suitable treatment support information, such as monitoring and prediction of a circulatory disease, in a medical treatment and healthcare field, by performing a simulation of a circulatory system such as a blood flow.

### Other Example Embodiments

In the fields of agriculture/farming support, flood prediction, medical treatment and healthcare, and the like presented in the fifth to seventh example embodiments, the present invention is applicable without being limited by a simulation target, by replacing the mathematical model calculation unit according to the first example embodiment with a model describing a behavior of a target, and parameters and observation values required for calculation of the model. For example, the present invention is applicable to mental health (early determination, prevention), a smart grid (supply-demand balance optimization), resource search (accuracy enhancement of spot prediction), and the like.

Further, while the present invention has been described with reference to the example embodiments, the present invention is not limited to the aforementioned example embodiments. Various changes and modifications that can be understood by a person skilled in the art may be made to the configurations and details of the present invention, within the scope of the present invention. Further, a system or a device in which different features included in the respective example embodiments are appropriately combined is also included in the scope of the present invention.

Further, the present invention may be applied to a system composed of a plurality of pieces of equipment, or may be applied to a single device. Additionally, the present invention is applicable to a case that an information processing program providing a function of the example embodiments is directly or remotely supplied to a system or a device. Accordingly, a program installed on a computer for providing a function of the present invention by the computer, a medium storing the program, or a World Wide Web (WWW) server causing download of the program is also included in the scope of the present invention. Particularly, at least a non-transitory computer-readable medium storing a program causing a computer to execute the processing step included in the aforementioned example embodiments is included in the scope of the present invention.

A part of or all of the above-described example embodiments may be described as the following supplementary notes. However, the present invention exemplarily described in the above-described example embodiments is not limited to the following.

(Supplementary Note 1)

An information processing device that executes simulation using a mathematical model and observation data comprising:

mathematical model calculation means for calculating a prediction value reflecting uncertainty of the mathematical model on basis of first-parameters values assumed to be constant at grid points generated by discretizing a calculation domain of the simulation, second-parameters values assumed to be inconstant, and given data;

local data processing means for iterating update of the prediction values and the second-parameters values to improve a degree of consistency between the prediction values and observation values reflecting uncertainty; and

global data processing means for iterating update of the first-parameters value and control of processing by the local data processing means.

(Supplementary Note 2)

The information processing device according to supplementary note 1 further comprising

parameters classification means for classifying parameters in the mathematical model to the second parameters when the parameters are, at least, not uniform in the calculation domain of the mathematical model, or initial value of time-depending variables and, otherwise, classifying the parameters to the first parameters, wherein

the global data processing means iteratively controls classification by the parameters classification means and iteratively controls the processing by the local data processing means.

(Supplementary Note 3)

The information processing device according to supplementary note 2, wherein

the global data processing means iteratively updates the first-parameters values until a change of the first-parameters values before and after update and a change of the degree of consistency are less than a threshold value and controls classification by the parameters classification means when the change is not less than the threshold value even after a predetermined-iteration times update.

(Supplementary Note 4)

The information processing device according to any one of supplementary notes 1 to 3, wherein

the local data processing means includes likelihood calculation means for calculating likelihood representing an indicator of the degree of consistency and updates the prediction value and the second parameters values with using sequential likelihood at individual time step of calculation with the mathematical model and

the global data processing means updates the first parameters values with using cumulative likelihood obtained by integrating the sequential likelihoods at more than predetermined number of time steps.

(Supplementary Note 5)

The information processing device according to any one of supplementary notes 1 to 4, wherein

a dimension of the first parameters is higher than a dimension of the second parameters.

(Supplementary Note 6)

The information processing device according to any one of supplementary notes 1 to 5, wherein

the local data processing means receives the prediction values and the observation data and executes sequential Bayesian filtering relating to the sequential degree of consistency and, thereby, updates the prediction values and the second parameters values, wherein

the sequential Bayesian filtering is a particle filtering, ensemble Kalman filtering, Kalman filtering, or Bayesian filtering including sequential weighted sampling.

(Supplementary Note 7)

The information processing device according to any one of supplementary notes 1 to 6, wherein

the global data processing means receives result values of multiplication of the first parameters values before update and the degree of consistency, executes statistical sampling including Markov Chain Monte Carlo method, and, thereby, updates the first-parameters values.

(Supplementary Note 8)

The information processing device according to any one of supplementary notes 1 to 7 includes

m(m≥2) local data processing means for obtaining observation values for respective sub-areas to be a target of the mathematical model, wherein

the global data processing means inputs the first-parameters values, the second-parameters values, and the given data to each of the m local data processing means and summarizes processing results of the m local data processing means.

(Supplementary Note 9)

The information processing device according to supplementary note 8, wherein

the sub-areas are obtained by dividing whole simulation target domain into local areas and are set at each grid point, at each block representing a set of the grid points more than 2, or at each target local areas.

(Supplementary Note 10)

The information processing device according to any one of supplementary notes 1 to 9, further comprising:

a history database for storing information where, at least, mathematical model as simulation target, the updated first-parameters values, the updated second-parameters values, the given data, and likelihood of simulation results are associated with each other wherein,

the global data processing means refers to the history database and stores, at least, mathematical model of simulation, initial values of the first parameters, initial values of the second parameters, and given data.

(Supplementary Note 11)

The information processing device according to supplementary note 2 or supplementary note 3

simulates prediction values of farming, wherein

the mathematical model is a crop growth model,

the parameters are farming environment parameters,

initial values of the first parameters are crop-types parameters,

initial values of the second parameters are soil parameters,

the given data is terrain data, weather data, and farming data, and

the observation data is data based on a satellite image or data based on a soil sensor.

(Supplementary Note 12)

The information processing device according to supplementary note 2 or supplementary note 3

simulates prediction values of flood, wherein

the mathematical model is a flood prediction model,

the parameters are flood environment parameters,

initial values of the first parameters are terrain parameters,

initial values of the second parameters are rivers parameters or soil parameters,

the given data is weather data and radar data, and

the observation data is for measured water level.

(Supplementary Note 13)

The information processing device according to supplementary note 2 or supplementary note 3

simulates prediction values of vital, wherein

the mathematical model is a circulatory system model,

the parameters are vital parameters,

initial values of the first parameters are macro vital parameters,

initial values of the second parameters are micro vital parameters,

the given data is standard vital data, and

the observation data is for measured vital data.

(Supplementary Note 14)

A simulation method with a mathematical model and observation data comprising:

mathematical model calculation means which calculating a prediction value reflecting uncertainty of the mathematical model on basis of first-parameters values assumed to be constant at grid points generated by discretizing a calculation domain of the simulation, second-parameters values assumed to be inconstant, and given data;

iterating update of the prediction values and the second-parameters values to improve a degree of consistency between the prediction values and observation values reflecting uncertainty; and

iterating update of the first-parameters value and control of update processing of the prediction values and the second-parameters.

(Supplementary Note 15)

A recoding medium storing a simulation program simulating with a mathematical model and observation data and causing a computer to achieve:

a mathematical model calculation function for calculating a prediction value reflecting uncertainty of the mathematical model on basis of first-parameters values assumed to be constant at grid points generated by discretizing a calculation domain of the simulation, second-parameters values assumed to be inconstant, and given data;

a local data processing function for iterating update of the prediction values and the second-parameters values to improve a degree of consistency between the prediction values and observation values reflecting uncertainty; and

a global data processing function for iterating update of the first-parameters value and control of processing by the local data processing function.

(Supplementary Note 16)

An Information processing system comprising:

sensor for obtaining observation data;

information processing device according to any one of supplementary notes 1 to 13 executes simulation based on a mathematical model by using the observation data; and

outputting means for requiring the information processing device for executing simulation based on the mathematical model and outputting a result of the simulation.

This application is based upon and claims the benefit of priority from Japanese patent application No. 2016-071460, filed on Mar. 31, 2016, the disclosure of which is incorporated herein in its entirety.

What is claimed is:

1. An information processing device that executes simulation using a mathematical model and observation data comprising:
a mathematical model calculator configure to calculate a prediction value reflecting uncertainty of the mathematical model on basis of first-parameters values assumed to be constant at grid points generated by discretizing a calculation domain of the simulation, second-parameters values assumed to be inconstant, and given data;
a local data processor configure to iterate update of the prediction values and the second-parameters values to improve a degree of consistency between the prediction values and observation values reflecting uncertainty; and
a global data processor configured to iterate update of the first-parameters value and control of processing by the local data processor.

2. The information processing device according to claim 1 further comprising
a parameters classifier configured to classify parameters in the mathematical model to the second parameters when the parameters are, at least, not uniform in the calculation domain of the mathematical model, or initial value of time-depending variables and, otherwise, classify the parameters to the first parameters, wherein
the global data processor iteratively controls classification by the parameters classifier and iteratively controls the processing by the local data processor.

3. The information processing device according to claim 2, wherein
the global data processor iterates update of the first-parameters values until a change of the first-parameters values before and after update and a change of the degree of consistency are less than a threshold value and controls classification by the parameters classifier when the change is not less than the threshold value even after a predetermined-iteration times update.

4. The information processing device according to claim 1, wherein
the local data processor includes likelihood calculator for calculating likelihood representing an indicator of the degree of consistency and updates the prediction value and the second parameters values with using sequential likelihood at individual time step of calculation with the mathematical model and
the global data processor updates the first parameters values with using cumulative likelihood obtained by integrating the sequential likelihoods at more than predetermined number of time steps.

5. The information processing device according to claim 1, wherein
a dimension of the first parameters is higher than a dimension of the second parameters.

6. The information processing device according to claim 1, wherein
the local data processor receives the prediction values and the observation data and executes sequential Bayesian filtering relating to the sequential degree of consistency and, thereby, updates the prediction values and the second parameters values, wherein
the sequential Bayesian filtering is a particle filtering, ensemble Kalman filtering, Kalman filtering, or Bayesian filtering including sequential weighted sampling.

7. The information processing device according to claim 1, wherein
the global data processor receives result values of multiplication of the first parameters values before update and the degree of consistency, executes statistical sampling including Markov Chain Monte Carlo method, and, thereby, updates the first-parameters values.

8. The information processing device according to claim 1 includes
m(m≥2) local data processors configured to obtain observation values for respective sub-areas to be a target of the mathematical model, wherein
the global data processor inputs the first-parameters values, the second-parameters values, and the given data to each of the m local data processor and summarizes processing results of the m local data processors.

9. The information processing device according to claim 8, wherein
the sub-areas are obtained by dividing whole simulation target domain into local areas and are set at each grid point, at each block representing a set of the grid points more than 2, or at each target local areas.

10. The information processing device according to claim 1, further comprising
a history database configured to store information where, at least, mathematical model as simulation target, the updated first-parameters values, the updated second-parameters values, the given data, and likelihood of simulation results are associated with each other wherein,
the global data processors refers to the history database and stores, at least, mathematical model of simulation, initial values of the first parameters, initial values of the second parameters, and given data.

11. The information processing device according to claim 2 simulates prediction values of farming, wherein
the mathematical model is a crop growth model,
the parameters are farming environment parameters,
initial values of the first parameters are crop-types parameters,
initial values of the second parameters are soil parameters,
the given data is terrain data, weather data, and farming data, and
the observation data is data based on a satellite image or data based on a soil sensor.

12. The information processing device according to claim 2 simulates prediction values of flood, wherein
the mathematical model is a flood prediction model,
the parameters are flood environment parameters,
initial values of the first parameters are terrain parameters,
initial values of the second parameters are rivers parameters or soil parameters,
the given data is weather data and radar data, and
the observation data is for measured water level.

13. The information processing device according to claim 2 simulates prediction values of vital, wherein
the mathematical model is a circulatory system model,
the parameters are vital parameters,
initial values of the first parameters are macro vital parameters,
initial values of the second parameters are micro vital parameters,
the given data is standard vital data, and
the observation data is for measured vital data.

14. A simulation method with a mathematical model and observation data comprising:
calculating a prediction value reflecting uncertainty of the mathematical model on basis of first-parameters values assumed to be constant at grid points generated by discretizing a calculation domain of the simulation, second-parameters values assumed to be inconstant, and given data;
iterating update of the prediction values and the second-parameters values to improve a degree of consistency between the prediction values and observation values reflecting uncertainty; and
iterating update of the first-parameters value and control of update processing of the prediction values and the second-parameters.

15. A non-transitory recoding medium storing a simulation program simulating with a mathematical model and observation data and causing a computer to achieve:
a mathematical model calculation function configured to calculate a prediction value reflecting uncertainty of the mathematical model on basis of first-parameters values assumed to be constant at grid points generated by discretizing a calculation domain of the simulation, second-parameters values assumed to be inconstant, and given data;
a local data processing function configured to iterate update of the prediction values and the second-parameters values to improve a degree of consistency between the prediction values and observation values reflecting uncertainty; and
a global data processing function configured to iterate update of the first-parameters value and control of processing by the local data processing function.

16. (canceled)
